(19) United States
(12) Patent Application Publication
(10) Pub. No.: US 2003/0070146 A1
(43) Pub. Date: Apr. 10, 2003

(54) Information processing apparatus and method

(76) Inventors: Junko Sato, Kanagawa (JP); Kenichi Kazumi, Kanagawa (JP); Koji Nakagiri, Kanagawa (JP); Yasuo Mori, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/238,693

(22) Filed: Sep. 11, 2002

(30) Foreign Application Priority Data
Sep. 14, 2001 (JP) 2001-280392
Feb. 1, 2002 (JP) 2002-025962
Jul. 30, 2002 (JP) 2002-222025

(51) Int. Cl. G06F 15/00

(52) U.S. Cl. 715/525

(57) ABSTRACT

An information processing apparatus which prints a chapter name on the tab of an index sheet stores document information as a document file including at least pieces of information about a chapter and a page included in the chapter. The information processing apparatus sets and stores information about an index sheet to be inserted between predetermined pages of the stored document information. The information processing apparatus sets and registers a format including the character font, style, size, and color of a character string to be printed on the tab of the index sheet. The information processing apparatus performs printing on each page included in the document information and on the tabbed index sheet on the basis of the document information stored in the document file, the information about the insertion paper sheet, and the set/registered tab format.

### FIELD OF THE INVENTION

The present invention relates to an information processing apparatus and method which provide a print setting function for document data generated by, e.g., a document processing program.

### BACKGROUND OF THE INVENTION

Different types of data such as characters, tables, and images require different structures which define the data and different editing operations for the data. Various application programs are provided in accordance with various types of data. The user who utilizes these data must use different applications for different types of data: a character processing program in order to edit characters, a spreadsheet program in order to edit tables, and an image editing program in order to edit images.

In this way, the user generally uses different application programs for different types of data. In general, a document to be created by the user is made up of a plurality of types of data such as characters and tables, or characters and images, rather than a document formed from only one type of data such as characters, tables, or images. To create a document containing a plurality of types of data, the user must use the printing functions of various applications to print respective data, and combine the printed materials in a desired order to create a desired document.

Some programs such as “Office Suite” which forms one integrated application from various applications provide a function of combining data generated by respective applications into one document. The use of the integrated application allows the user to combine data created by respective applications into one target document by using a specific application included in the integrated application.

However, to assign page numbers to pages when the user creates one target document by combining print materials generated by various applications, he/she must print out all necessary data, combine the printed materials into a document, and determine page numbers. Even if the application program has a function of assigning page numbers, the page numbers of discontinuous pages must be designated by the user. If the pages of the document are rearranged, page numbers must be reassigned in accordance with the rearrangement. Data must also be edited and printed again by an application when not data contents but merely the document format is changed such that a plurality of original pages are combined into one page (to be referred to as a physical page or print page) as a print material, or single-sided printing is changed to double-sided printing.

Since an application which can manage data changes depending on the type of data, the user must manually provide an interface between applications. This means that much labor is demanded of the user, decreasing the productivity. The many manual operations readily generate errors.

The use of an integrated application for creating a document enables arranging various data in the data state by using a print preview or the like without actually printing them out. With the use of this function, no heavy labor is required in comparison with creation of a document by combining print materials. However, applications for editing and creating various data are restricted to ones included in the integrated application, so a user-desired application may not be exploited. A document created by the integrated application is one document file, and management such as editing and output is done for each file. The application function poses many constraints on setting the format of part of the document file. For example, the user must change format settings at each portion where the format is changed, and print a target page again. This leads to much labor and low productivity, similar to the above-mentioned method.

The integrated application is providing a larger number of functions. In recent years, the user wants an environment where he/she can perform all DTP (DeskTop Publishing) functions on a computer. As one of user's utilization cases, the user may want an environment where another page, e.g., an index sheet is inserted into a document file to print data. At present, however, no integrated application can insert an index sheet into a document. When a tabbed index sheet (to be also referred to as a tab sheet) is used as the index sheet, index sheet information to be printed on the tab of the index sheet must be generated one by one as a page of document data by the user using an application. Index sheet information generated using the application is one page of document data. To change the insertion portion of the index sheet, a document page (index sheet information) must be added again to the changed portion, requiring much labor from the user. Since the user creates an index sheet as a document page, the tab position slightly shifts or it is difficult to designate the layout of a character string to be printed at the tab position of the index sheet (because “right justification” or “left justification” cannot be set in consideration of the tab size).

### SUMMARY OF THE INVENTION

The present invention has been made in consideration of the above situation, and has as the first object to provide an information processing apparatus and method capable of setting an arbitrary format of a character string to be printed on the tab of a paper sheet, e.g., index sheet inserted between predetermined pages of document information, and printing the character string.

It is the second object of the present invention to provide an information processing apparatus and method capable of creating and editing a document made up of data created by user-desired application programs, and dividing one document into a plurality of chapters to insert an index sheet at a chapter break with a simple operation.

In order to attain the above described objects, an information processing apparatus of the present invention comprises tab setting means for setting information about a tab of an insertion paper sheet to be inserted between predetermined pages of document information; and format setting/registering means for setting and registering a format of a character string to be printed on the tab of the insertion paper sheet set by the tab setting means, wherein the tab setting means changes a setting candidate of a layout for printing on a tab of an index sheet in accordance with a font type of the character string to be printed on a selected tab.

In order to attain the above described objects, an information processing method of the present invention comprises a setting step of setting information about an insertion paper sheet to be inserted between predetermined pages of document information; a document management step of managing, in a document file of the document information, the information about the insertion paper sheet set in the setting step; and an output step of reading out the information about the insertion paper sheet from the document file and outputting the information to a printer driver when the document information of the document file managed in the document management step is to be printed.

Other features and advantages of the present invention will be apparent from the following descriptions taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the descriptions, serve to explain the principle of the invention.

FIG. 1 is a block diagram for explaining the arrangement of a stand-alone document processing system according to an embodiment of the present invention;

FIG. 2 is a block diagram showing the arrangement of a host computer in the document processing system according to the embodiment;

FIG. 3A depicts a view schematically showing an example of a book file format;

FIG. 3B depicts a view showing an original data structure;

FIGS. 4A and 4B depict tables showing an example of a book attribute according to the embodiment;

FIG. 5 depicts a table showing an example of a chapter attribute according to the embodiment;

FIG. 6 depicts a table showing an example of a page attribute according to the embodiment;

FIG. 7 is a flow chart for explaining procedures of opening a book file in according to the embodiment;

FIG. 8 is a flow chart for explaining procedures of importing an electronic original file into a book file according to the embodiment;

FIG. 9 is a flow chart for explaining procedures of converting application data into an electronic original file according to the embodiment;

FIG. 10 depicts a view showing an example of a user interface window when an existing book file is opened;

FIG. 11 depicts a view showing an example of a user interface window when a new book file is opened;

FIG. 12 is a block diagram showing the arrangement of a client-server document processing system according to the embodiment;

FIG. 13 is a block diagram for explaining the arrangements of a host computer and printer in the document processing system according to the embodiment of the present invention;

FIG. 14 is a flow chart for explaining write of a character string on a tab in the document processing system according to the embodiment of the present invention;

FIG. 15 depicts a view showing an example of a user interface window for setting insertion of an index sheet according to the embodiment;

FIGS. 16, 17, and 18 depict views showing examples of a user interface window for setting a character string on the tab of an index sheet according to the embodiment;

FIG. 19 depicts a view showing a data structure of a document file according to the embodiment;

FIG. 20 depicts a view showing a data structure of detailed document setting information according to the embodiment;

FIG. 21 depicts a view showing index sheet information of each chapter according to the embodiment;

FIG. 22 depicts a view showing detailed setting information of each chapter according to the embodiment;

FIG. 23 depicts a view for explaining the data structure of page setting information of each chapter;

FIG. 24 depicts a view for explaining a display example when tab information of an index sheet is edited;

FIG. 25 is a flow chart showing processing of controlling editing and preview display of index sheet information according to the embodiment;

FIG. 26 is a flow chart for explaining index sheet setting processing according to the embodiment;

FIG. 27 is a flow chart showing print processing of document information including index sheet information according to the embodiment;

FIG. 28 depicts a view showing an example of the preview display of original pages including index sheets when index sheet setting and tab print setting according to the embodiment are performed;

FIG. 29 depicts a view showing an example in which automatic adjustment setting of the character size and line feed setting are performed in a user interface window for setting a character string on the tab of an index sheet according to the embodiment;

FIG. 30 is a flow chart for explaining adjustment processing of a character size to be printed within the tab and line feed processing according to the embodiment;

FIG. 31 depicts a view for explaining a printable region on the tab of an index sheet according to the embodiment;

FIGS. 32, 33, and 34 depict views showing examples of a user interface window for setting a character string on the tab of an index sheet according to another embodiment of the present invention;

FIG. 35 depicts a view showing an example of a user interface window in which it is designated to print a character string of a European font on a tab in the longitudinal direction according to the embodiment shown in FIGS. 32 to 34;

FIG. 36 is a flow chart for explaining write processing of a character string on a tab in the document processing system according to the embodiment shown in FIGS. 32 to 34; and

FIG. 37 depicts a view for explaining tab setting processing for printing a character string of the European font on the tab of an index sheet in the longitudinal direction according to the embodiment shown in FIGS. 32 to 34.

### DETAILED DESCRIPTION OF THE PREFERRED EMBODIMENTS

Preferred embodiments of the present invention will be described in detail below with reference to the accompanying drawings.

<General Description of System>

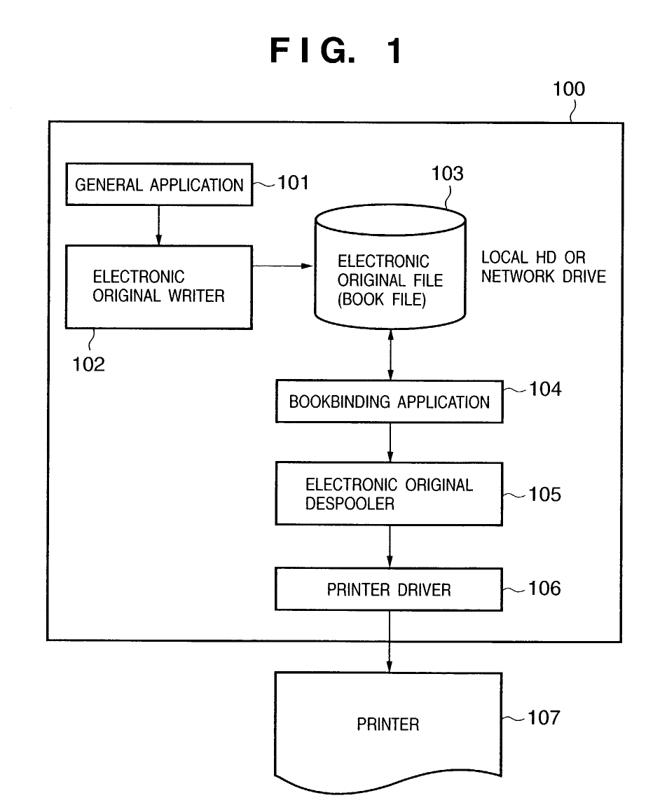

A document processing system according to the first embodiment of the present invention will be described with reference to FIGS. 1 to 12. This document processing system converts a data file created by a general application into an electronic original file by an electronic original writer. A bookbinding application provides a function of editing the electronic original file. Details of the system will be explained below.

<System Configuration and Operation>

FIG. 1 is a block diagram showing the software structure of the document processing system suitable for an information processing system according to the first embodiment of the present invention.

The document processing system is implemented by a digital computer 100 serving as a preferred embodiment of an information processing apparatus according to the first embodiment. A general application 101 is an application program which provides functions such as words-processing, spreadsheet, photo-retouch, draw, paint, presentation, and text editing. The general application 101 has a printing function. These applications utilize a predetermined interface provided by the OS (Operating System) in printing application data such as created document data or image data. To print created data, the application 101 transmits, to the output module of the OS providing the interface, an output command (GDI function) which is determined in advance and has an OS-dependent format. The output module which has received the output command converts the command into a format processible by an output device such as a printer, and outputs the converted command (DDI function). Since the format processible by the output device changes depending on the type of device, the manufacturer, and the model, a device driver is provided for each device. The OS generates print data by converting commands by using the device driver, and generates a print job by combining the print data by JL (Job Language). When the OS is, for example, Microsoft Windows®, the output module is a GDI (Graphic Device Interface) module.

An electronic original writer 102 is an improvement of the above-mentioned device driver, and is a software module provided to implement the document processing system. The electronic original writer 102 does not target a specific output device, and generates an electronic original file 103 by converting an output command into a format processible by a bookbinding application 104 or printer driver 106 (to be described later). The format (to be referred to as an “electronic original format” hereinafter) converted by the electronic original writer 102 is not particularly limited as far as each original page can be expressed by a detailed format. Of substantial standard formats, for example, the PDF format by Adobe Systems and the SGML format can be adopted as electronic original formats. When the application 101 utilizes the electronic original writer 102, the electronic original writer 102 is designated as a device driver used for output, and then caused to execute printing. An electronic original file created by the electronic original writer 102 does not have a complete electronic original file format. For this reason, the electronic original writer 102 is designated as a device driver by the bookbinding application 104, and executes conversion of application data into an electronic original file under the management of the bookbinding application 104. The bookbinding application 104 completes a new incomplete electronic original file generated by the electronic original writer 102 as an electronic original file having the following format. In case of necessity to definitely discriminate these files, a file created by the electronic original writer 102 will be called an “electronic original file”, and an electronic original file given a structure by the bookbinding application will be called a “book file”. If these files need not be particularly discriminated, a document file generated by an application, an electronic original file, and a book file are called document files (or document data).

As described above, the electronic original writer 102 is designated as a device driver, and the general application 101 prints the data. Application data is converted into an electronic original format in pages (to be referred to-as “logical pages” or “original pages” hereinafter) defined by the application 101. The converted data is stored as the electronic original file 103 in a storage medium such as a hard disk. The hard disk may be the local drive of the computer which implements the document processing system according to the first embodiment, or when the computer is connected to a network, may be a drive provided on the network.

The bookbinding application 104 provides the user with a function of loading and editing the “electronic original file” or “book file” 103. The bookbinding application 104 provides no function of editing the contents of each page, but a function of editing a chapter or book structure (to be described later) made up of pages as a minimum unit.

To print the book file 103 edited by the bookbinding application 104, the bookbinding application 104 activates an electronic original despooler 105. The electronic original despooler 105 reads out a designated book file from the hard disk. To print each page in a format described in the book file, the electronic original despooler 105 generates an output command complying with the output module of the OS described above, and outputs the command to the output module (not shown). At this time, the printer driver 106 for a printer 107 used as an output device is designated as a device driver. The output module converts the output command received using the designated printer driver 106 of the printer 107 into a device command interpretable by the printer 107. The device command is transmitted to the printer 107, which prints an image corresponding to the command.

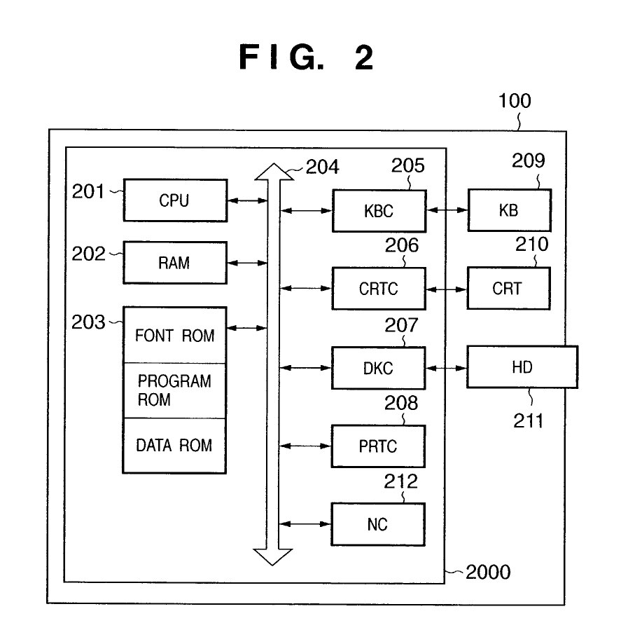

FIG. 2 is a block diagram showing the hardware arrangement of the digital computer 100 shown in FIG. 1.

In FIG. 2, a CPU 201 executes a program such as an OS, general application 101, or bookbinding application 104 which is stored in the program ROM of a ROM 203 or loaded from a hard disk 211 to a RAM 202, and realizes the software structure in FIG. 1 or flow chart procedures (to be described later). The RAM 202 functions as the main memory or work area of the CPU 201. A keyboard controller (KBC) 205 controls a key input from a keyboard 209 or a pointing device (not shown). A CRT controller (CRTC) 206 controls the display on a display 210. The display 210 is not limited to a CRT, and may be a liquid crystal display or plasma display. A disk controller (DKC) 207 controls access to the hard disk (HD) 211 or floppy disk (FD) (not shown) which stores a boot program, various applications, font data, user files, editing files (to be described later), and the like. A PRTC 208 controls signal exchange with the connected printer 107. A NC 212 is connected to a network, and executes communication control processing with another device connected to the network.

<Electronic Original Data Format>

Before the bookbinding application 104 is described in detail, the “book file” data format will be explained.

The book file has a three-layered structure similar to a paper-medium book. The upper layer is called a “book”, resembles one book, and defines the attributes of the entire book. The intermediate layer corresponds to a chapter in the book, and is also called a “chapter”. As for each “chapter”, its attributes can be defined. The lower layer is a “page”, and corresponds to each page defined by an application program. As for each “page”, its attributes can be defined. One “book” may include a plurality of “chapters”, and one “chapter” may include a plurality of “pages”.

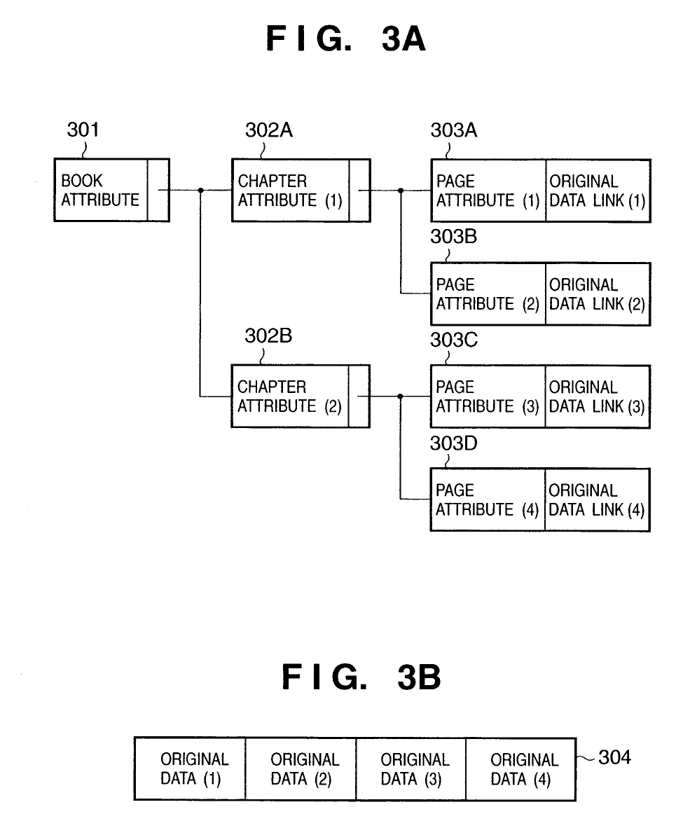

FIG. 3A is a view schematically showing an example of the book file format. In the book file of this example, “book”, “chapter”, and “page” are represented by corresponding nodes. One book file includes one “book”. “Book” and “chapter” are a concept for defining a book structure, and contain, as entities, defined attribute values and links to lower layers. “Page” has, as an entity, data of each “page” output from an application program. In addition to an attribute value, “page” contains the entity of an original page (original page data) and a link to each original page data. In some cases, a print page to be output onto a paper medium or the like includes a plurality of original pages. This structure is displayed not by a link but by an attribute in the “book”, “chapter”, or “page” layer.

In FIG. 3A, a book 301 defines a book attribute, and is linked to two chapters 302A and 302B. These links display that the chapters 302A and 302B are included in the book 301. The chapter 302A is linked to pages 303A and 303B, which represents that the chapter includes these pages. The pages 303A and 303B define the attribute values of the respective pages, and contain links to original page data (1) and (2) serving as entities. These links represent original data (1) and (2) of original page data 304 shown in FIG. 3B, and display that the entities of the pages 303A and 303B are original page data (1) and (2).

Similarly, the chapter 302B includes pages 303C and 303D, and contains links to original page data (3) and (4) serving as entities. These links represent original data (3) and (4) of the original page data 304 shown in FIG. 3B, and display that the entities of the pages 303C and 303D are original page data (3) and (4).

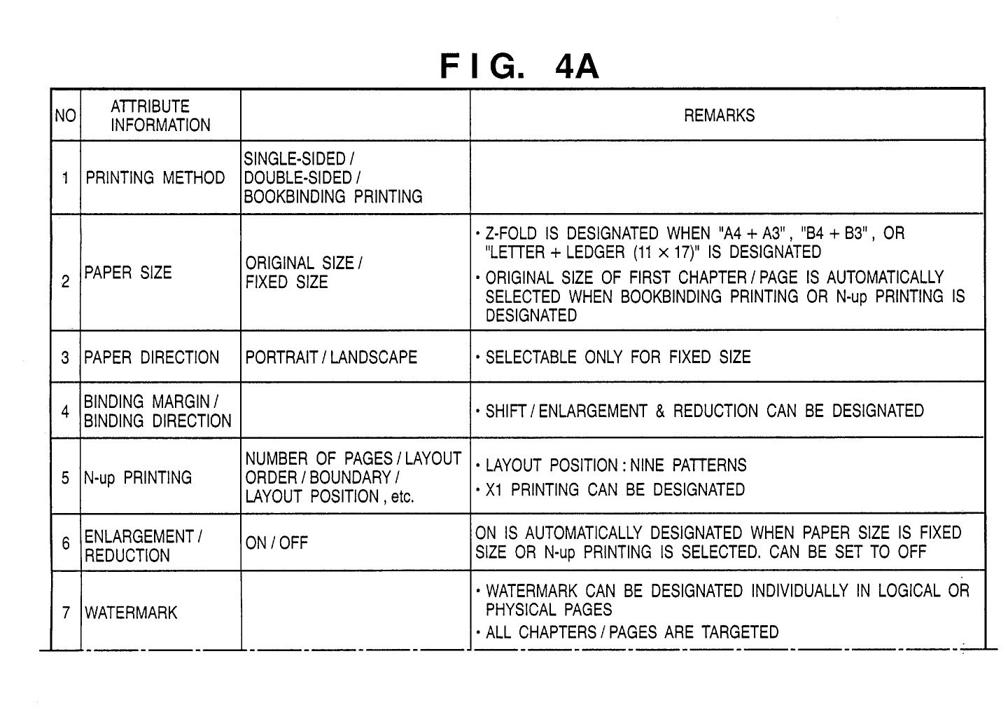

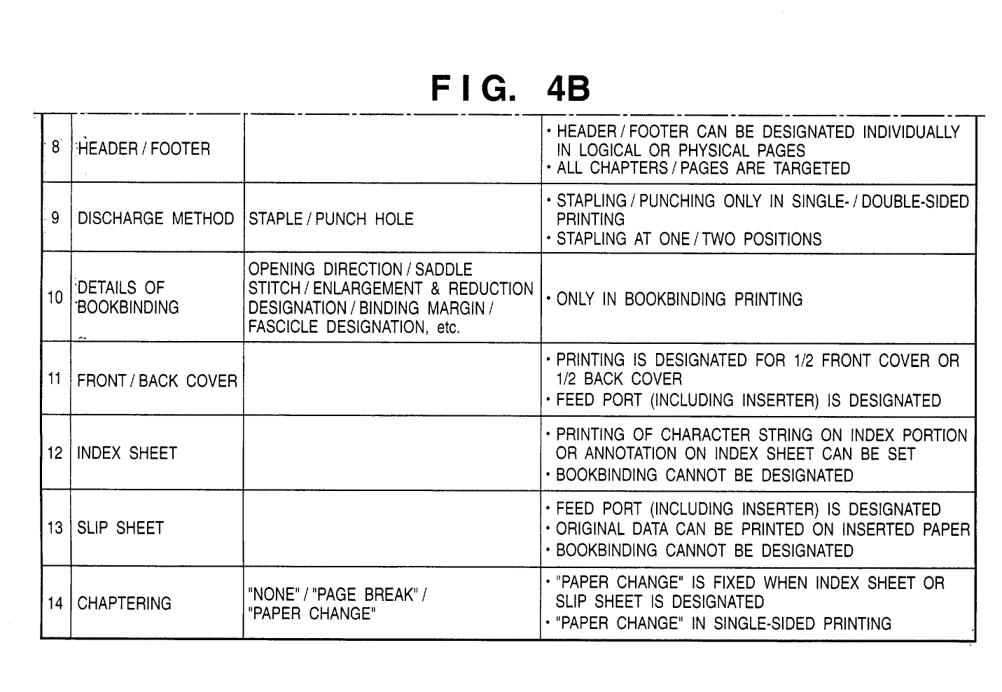

FIGS. 4A and 4B depict tables for explaining the book attribute 301 according to the first embodiment.

As for an attribute item which can be defined repetitively on a lower layer, the attribute value of the lower layer is preferentially adopted. As for an item contained in only the book attribute 301, a value defined in the book attribute 301 is effective over the book. An item repetitively defined on a lower layer is a default value used when this item is not defined in the lower layer. Each item shown in FIGS. 4A and 4B does not always correspond to one concrete item, but may contain a plurality of relevant items.

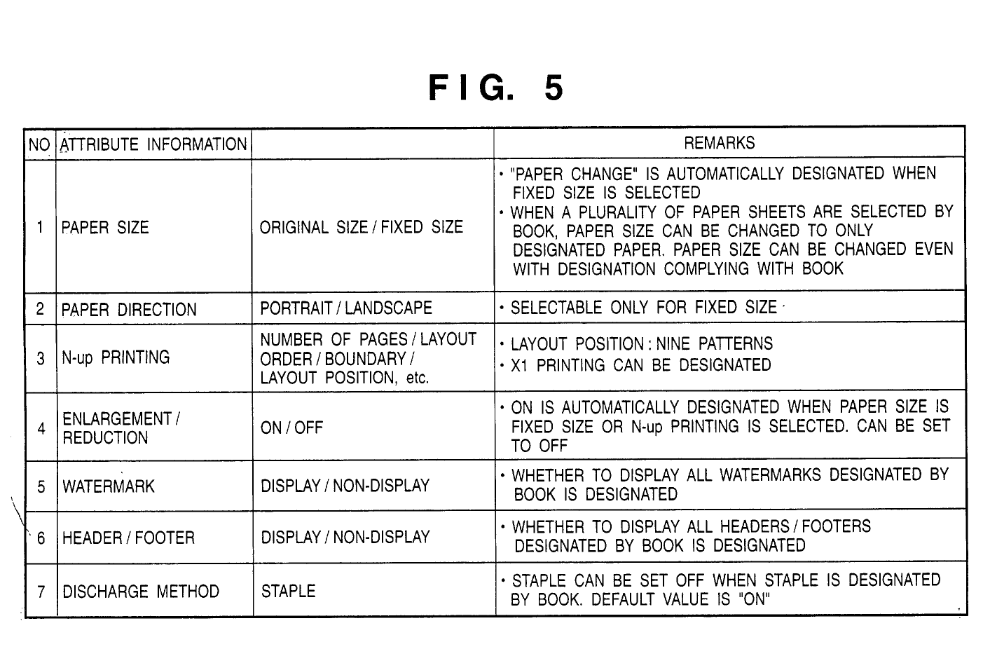

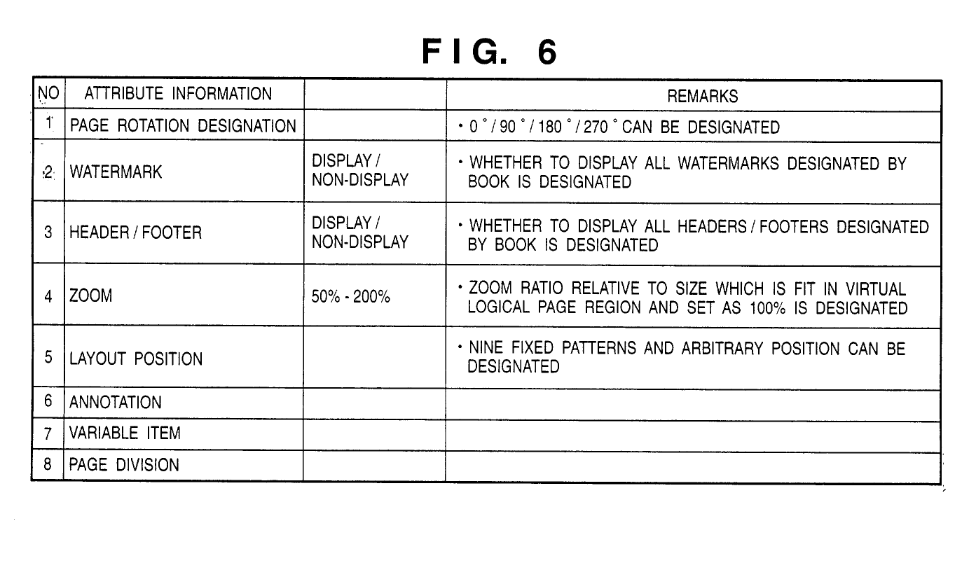

FIG. 5 is a table for explaining the chapter attribute according to the first embodiment, and FIG. 6 is a table for explaining the page attribute according to the first embodiment. The relationship between the chapter attribute and the page attribute is the same as that between the book attribute and the lower layer attribute.

In FIGS. 4A and 4B, items unique to the book attribute 301 are six items “printing method”, “details of bookbinding”, “front/back cover”, “index sheet”, “slip sheet”, and “chaptering”. These items are defined over the book.

As “printing method” attributes, three values “single-sided printing”, “double-sided printing”, and “bookbinding printing” can be designated. “Bookbinding printing” is a method of printing data in a format which allows bookbinding by bundling a separately designated number of paper sheets, folding the bundle into two, and binding the bundle. As “details of bookbinding”, “opening direction” and “the number of paper sheets to be bundled” can be designated when “bookbinding printing” is designated as “printing method”.

The “front/back cover” attribute includes designation of adding paper sheets serving as front and back covers when an electronic original file combined as a book is printed, and designation of contents to be printed on the added paper sheets. The “index sheet” attribute includes designation of inserting a tabbed index sheet separately prepared in a printing apparatus for chaptering, and designation of contents to be printed on the index (tabbed) sheet. This attribute becomes effective when a printing apparatus to be used is equipped with an inserter having an inserting function of inserting a paper sheet prepared separately from a print paper sheet into a desired position, or when a plurality of sheet cassettes can be used. This also applies to the “slip sheet” attribute. The “slip sheet” attribute includes designation of inserting a paper sheet fed from an inserter or sheet feed cassette for chaptering, and designation of a sheet feed source when a slip sheet is inserted.

The “chaptering” attribute includes designation of whether to use a new paper sheet, use a new print page, or do nothing particular at a chapter break. In “single-sided printing”, the use of a new paper sheet and the use of a new print page are the same. In “double-sided printing”, successive pages are not printed on one paper sheet if “the use of a new paper sheet” is designated, but may be printed on the upper and lower surfaces of one paper sheet if “the use of a new print page” is designated.

As for the chapter attribute shown in FIG. 5, there is no item unique to the chapter, and all items overlap those of the book attribute. If the definition of the chapter attribute is different from that of the book attribute, a value defined by the chapter attribute precedes. Attribute items common to only the book and chapter attributes are five items “paper size”, “paper direction”, “N-up printing designation”, “enlargement/reduction”, and “discharge method”. The “N-up printing designation” attribute is an item for designating the number of original pages included in one print page. Layouts which can be designated are 1×1, 1×2, 2×2, 3×3, 4×4, and the like. The “discharge method” attribute is an item for designating whether to staple discharged paper sheets. The effectiveness of this attribute depends on whether a printing apparatus to be used has a staple function.

In the page attribute shown in FIG. 6, items unique to the page attribute are “page rotation designation”, “zoom”, “layout designation”, “annotation”, and “page division”. “Page rotation designation” is an item for designating the rotation angle when an original page is laid out on a print page. The “zoom” attribute is an item for designating the zoom ratio of an original page. The zoom ratio is designated based on a virtual logical page region size=100%. The virtual logical page region is a region occupied by one original page when original pages are laid out in accordance with N-up designation or the like. For example, the virtual logical page region is a region corresponding to one print page for 1×1, and a region obtained by reducing each side of one print page to about 70% for 1×2.

Attributes common to “book”, “chapter”, and “page” described above are “watermark” and “header/footer” attributes. “Watermark” is a separately designated image or character string printed over data created by an application. “Header and footer” are watermarks printed at the upper and lower margins of each page. For “header and footer”, items such as a page number, and time and date which can be designated by variables are prepared. Contents which can be designated by the “watermark” and “header/footer” attributes are common to “chapter” and “page”, but are different in “book”. In “book”, “watermark” and “header/footer” contents can be set, and how to print “watermark” or “header/footer” throughout the book can be designated. In “chapter” and “page”, whether to print “watermark” or “header/footer” set in the book on the chapter or page can only be designated.

<Book File Generation Procedures>

A “book file” as an electronic original file given a structure by the bookbinding application 104 has the above-described structure and contents. Procedures of creating a book file by the bookbinding application 104 and electronic original writer 102 will be explained. Creation of a book file is realized as part of book file editing operation by the bookbinding application 104.

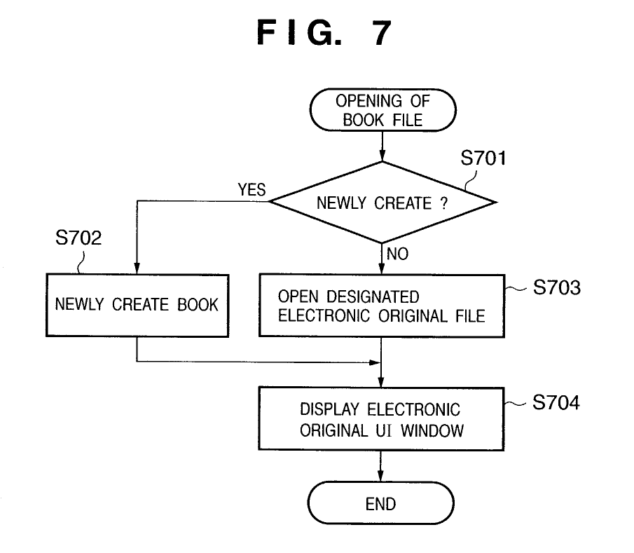

FIG. 7 is a flow chart for explaining procedures when the bookbinding application 104 according to the first embodiment opens a book file.

In step S701, whether a book file to be opened is one to be newly created or an existing one is checked. If YES in step S701, the flow shifts to step S702 to newly create a book file including no chapter. In the example shown in FIG. 3A, the newly created book file is a node which has only the book attribute 301 without any link to a chapter node. As the book attribute, a set of attributes prepared in advance for creation of a new book file are applied. Then, the flow proceeds to step S704 to display a UI (User Interface) window for editing the new book file.

FIG. 11 is a view showing an example of the UI window when a book file is newly created. In this case, a UI window 1100 does not display any information because the book file does not have any substantial content.

If NO in step S701, the flow proceeds to step S703 to open a designated book file, and display a UI (User Interface) window in accordance with the structure, attribute, and contents of the book file.

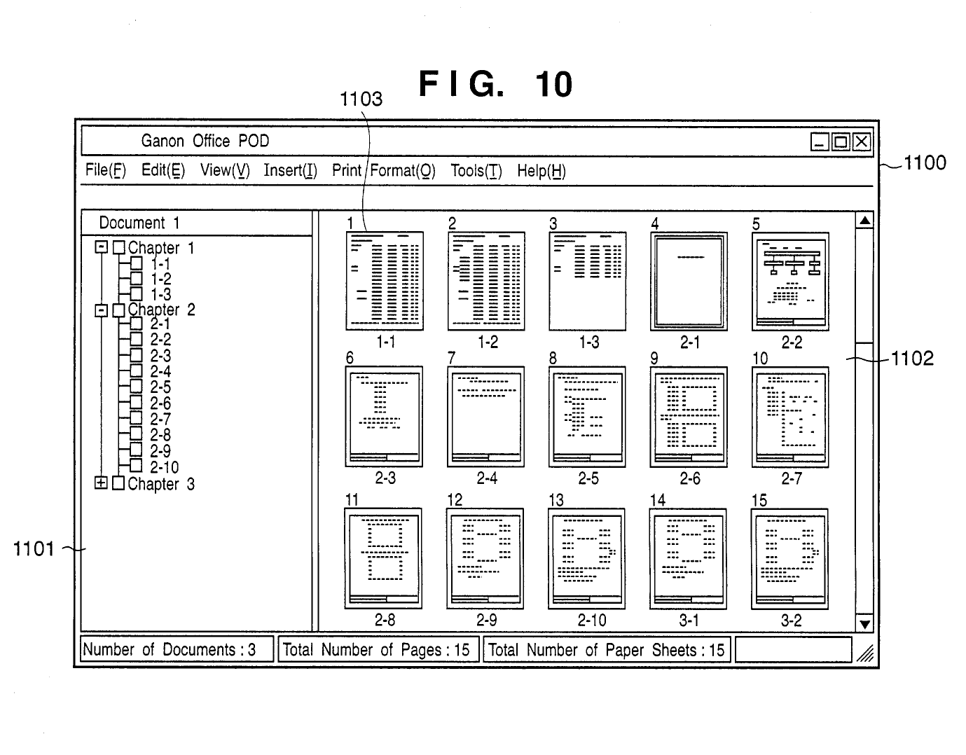

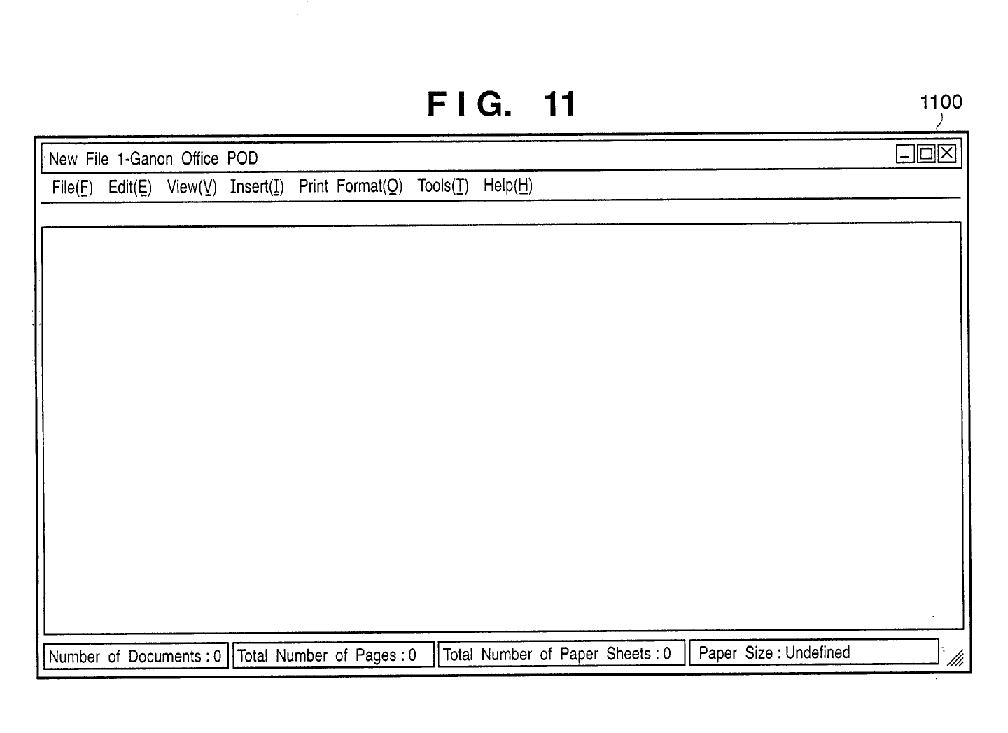

FIG. 10 is a view showing an example of the displayed UI window.

A UI window 1100 has a tree portion 1101 representing a book structure, and a preview portion 1102 displaying a state to be printed. The tree portion 1101 displays chapters included in the book and pages included in each chapter by a tree structure as shown in FIG. 3A. Page numbers are displayed at the tree portion 1101 and represent the number of original pages. The preview portion 1102 displays reduced print page contents. The display order reflects the book structure.

Application data converted into an electronic original file by the electronic original writer 102 can be added as a new chapter to the open book file. This function is called an “electronic original import function”. An electronic original is imported to the book file newly created along the procedures shown in the flow chart of FIG. 7, giving an entity to the book file. This function is activated by drag-and-drop operation of application data in the window of FIG. 10.

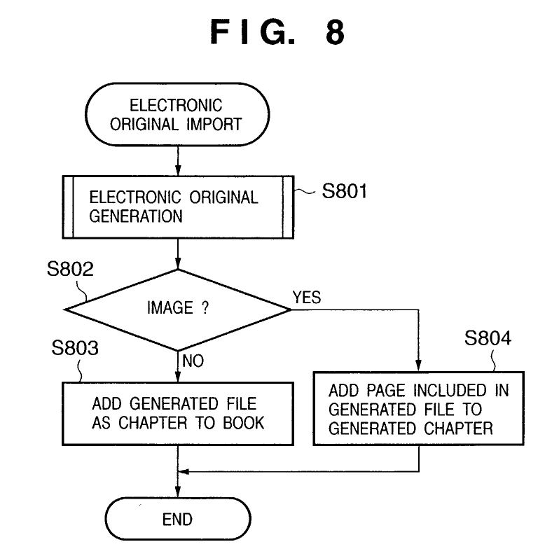

FIG. 8 is a flow chart showing electronic original import procedures according to the first embodiment.

An application program which has generated designated application data is activated. The electronic original writer 102 is designated as a device driver, and prints out application data to convert it into electronic original data (step S801). After conversion into the electronic original data, the flow advances to step S802 to check whether the converted data is image data. This determination can be achieved based on the file extension of the application under the Windows® OS. For example, an extension “bmp” represents bitmap data; “jpg”, jpeg-compressed image data; and “tiff”, tiff-format image data. If YES in step S802, processing in S801 can be skipped because an electronic original file can be directly generated from image data without activating an application in S801.

If NO in step S802, the flow advances to step S803 to add the electronic original file generated in step S801 as a new chapter to the book of a currently open book file. As for the chapter attribute, an attribute common to a book attribute is set to a book attribute value, and a different attribute is set to a default value prepared in advance.

If YES in step S802, the flow advances to step S804. No new chapter is added in principle, and each original page included in the electronic original file generated in step S801 is added to a designated chapter. For a file in which a book file is newly created, a new chapter is created, and each page of the electronic original file is added as a page belonging to the chapter. As for the page attribute, an attribute common to an upper layer attribute is given the attribute value of the upper layer attribute, and an attribute which is defined in application data and inherited to the electronic original file is given a value defined in the application data. For example, when “N-up designation” is defined in application data, the page inherits this attribute value. In this way, a new book file is created, or a new chapter is added.

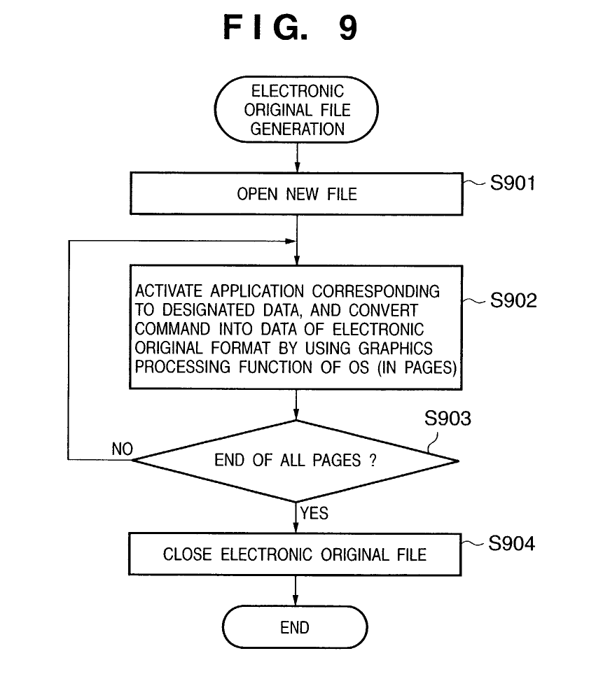

FIG. 9 is a flow chart showing procedures of generating an electronic original file by the electronic original writer 102 in step S801 of FIG. 8.

In step S901, a new electronic original file is created and opened. The flow proceeds to step S902 to activate an application corresponding to designated application data. The electronic original writer 102 is set as a device driver and transmits an output command to the output module of the OS. The output module converts the received output command into data of the electronic original format by the electronic original writer, and outputs the converted data. The output destination is the electronic original file opened in step S901. The flow shifts to step S903 to check whether all designated data have been converted. If YES in step S903, the flow proceeds to step S904 to close the electronic original file. The electronic original file generated by the electronic original writer 102 is a file containing original page data entities shown in FIG. 3B.

<Editing of Book File>

As described above, a book file can be created from application data. The generated book file allows editing a chapter and page as follows.

(1) New document

(2) Delete

(3) Copy

(4) Cut

(5) Paste

(6) Move

(7) Change chapter name

(8) Reassign page number/name

(9) Insert cover

(10) Insert slip sheet

(11) Insert index sheet

(12) Page layout of each original page

In addition, an operation of canceling executed editing operation, and an operation of restoring canceled operation can be performed. These editing functions enable editing operations such as consolidation of a plurality of book files, rearrangement of chapters and pages within a book file, delete of chapters and pages within a book file, layout change of an original page, and insertion of a slip sheet and index sheet. By these operations, operation results are reflected on attributes shown in FIGS. 4 to 6 or on a book file structure. For example, a blank page is inserted into a designated portion by an operation of newly adding a blank page. The blank page is processed as an original page. If the layout of an original page is changed, the change contents are reflected on attributes such as printing method, N-up printing, front/back cover, index sheet, slip sheet, and chaptering.

<Output of Book File>

The ultimate goal of a book file created and edited in the above manner is to print it out. The user selects a file menu from the UI 1100 of the bookbinding application shown in FIG. 10, and selects printing from this menu. Then, the book file is printed out from a designated output device. At this time, the bookbinding application 104 creates a job ticket from a currently open book file, and transfers the job ticket to the electronic original despooler 105. The electronic original despooler 105 converts the job ticket into an OS output command, e.g., a Windows GDI command, and transmits the command to an output module, e.g., GDI. The output module generates a command complying with an output device by a designated printer driver 106, and transmits the command to the output device.

The job ticket is data with a structure whose minimum unit is an original page. The data structure of the job ticket defines the layout of an original page on paper. One job ticket is issued for one job. A document node is set at the top of the structure, and defines the attribute of the whole document such as double-sided printing/single-sided printing. A paper node belongs to the document node, and contains attributes such as the identifier of paper for use and designation of a feed port in the printer. A node for a sheet printed by the paper belongs to each paper node. One sheet corresponds to one paper sheet. A print page (physical page) belongs to each sheet. One physical page belongs to one sheet for single-sided printing, and two physical pages belong to one sheet for double-sided printing. An original page to be laid out on a physical page belongs to the physical page. The physical page attribute contains an original page layout.

The electronic original despooler 105 converts the job ticket into an output command to the output module.

<Another System Configuration>

The document processing system according to the embodiment has generally been described. This system is of stand-alone type. A server-client system as an extension of the stand-alone system also creates and edits a book file by almost the same arrangement and procedures. A book file and print processing are managed by the server.

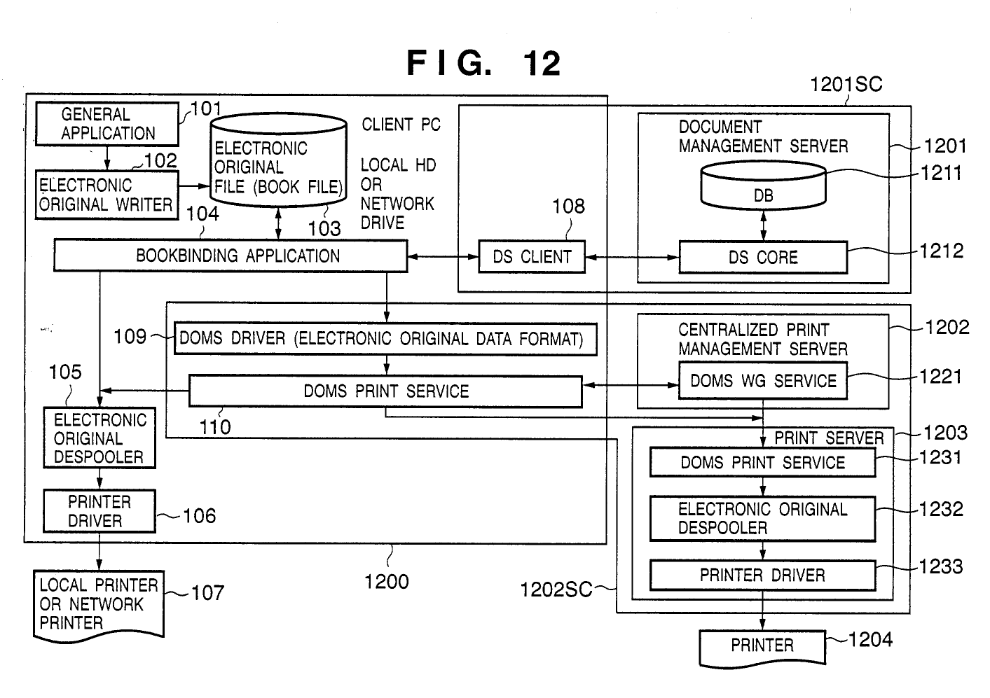

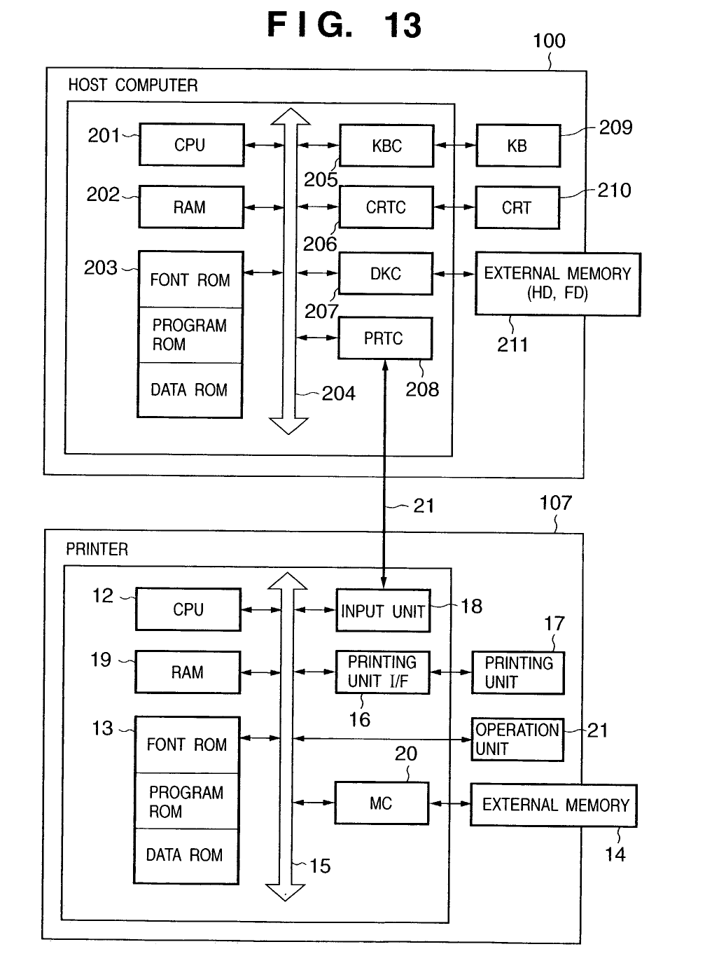

FIG. 12 is a block diagram showing the arrangement of a server-client document processing system according to the first embodiment.

A client document processing system 1200 has a structure including the stand-alone system a DOMS (Document Output Management Service) driver 109, DOMS print service module 110, and DS (Document Service) client module 108 serving as client modules. The client document processing system 1200 is connected to a document management server 1201, centralized print management server 1202, and print server 1203. These servers are generally connected to the client document processing system 1200 via a network. When the servers also function as clients, they are connected by interprocess communication which simulates communication between networks. The document management server 1201 and centralized print management server 1202 are connected to the client in FIG. 12, but only either one may exist on the network. If the connected server is the document management server, a document management server-client system 1201SC including a client module is added to the stand-alone document management system. If the connected server is the centralized print management server 1202, a print management server-client system 1202SC including a client module is added.

The document management server 1201 stores a book file created and edited by the bookbinding application 104. To manage a book file by the document management server 1201, the book file is saved in a database 1211 of the document management server 1201 instead of or in addition to the local HD of a client PC. Save and read of a book file between the bookbinding application 104 and the document management server 1201 are done via the DS client module 108 and a DS core 1212.

The centralized print management server 1202 manages printing of a book file stored in the client document processing system 1200 or document management server 1201. A print request from the client is transmitted to a DOMS WG server module 1221 of the centralized print management server 1202 via the DOMS driver 109 and DOMS print service module 110. To print a book file by the printer 107 of the client, the centralized print management server 1202 transfers electronic original data to the electronic original despooler 105 via the DOMS print service module 110 of the client.

To print a book file by the print server 1203, the centralized print management server 1202 transmits electronic original data to a DOMS print service module 1231 of the print server 1203. For example, the centralized print management server 1202 executes security check on the qualification of a user who has issued a print request for a saved book file, or saves the print processing log. In this fashion, the document processing system can be implemented as both a stand-alone system and client-server system.

<Contents of Preview Display>

As described above, when a book file is opened by the bookbinding application 104, the user interface window 1100 shown in FIG. 10 is displayed. The tree portion 1101 displays a tree representing the structure of the open book (to be referred to as a “book of interest” hereinafter). The preview portion 1102 has three display methods in accordance with user designation. The first method is an “original view mode” where original pages are directly displayed. In the “original view mode”, the contents of original pages belonging to a book of interest are reduced and displayed. The display at the preview portion 1102 does not reflect any original layout. The second method is a “print view mode”. In the “print view mode”, the preview portion 1102 displays original pages in accordance with the layout of the original pages. The third method is a “simple print view mode”. In the “simple print view mode”, the contents of each original page are not reflected on the display at the preview portion 1102, and only the layout is reflected.

Before a description of the features of the embodiment of the present invention, the arrangement of a document processing system having the host computer 100 (corresponding to the information processing apparatus of the present invention) and printer 107 which can be applied to this embodiment will be explained. The arrangement of the host computer 100 (to be also referred to as a client hereinafter) is the same as that described above with reference to FIG. 2. The same reference numerals denote the same parts, and a description thereof will be omitted. The printer 107 can be a local printer connected to a client or a printer 1204 (FIG. 12) connected to a server.

FIG. 13 is a block diagram for explaining the arrangement of the document processing system according to the embodiment of the present invention. As long as functions according to this embodiment are executed, the present invention can be applied to a single device, a system made up of a plurality of devices, or a system which is connected via a LAN, WAN, or the like and performs processing. The arrangement of the host computer 100 is the same as that described above with reference to FIG. 2, and a description thereof will be omitted.

The printer 107 is controlled by a CPU 12. The CPU 12 outputs an image signal as output information to a printing unit (printer engine) 17 connected to a system bus 15 on the basis of a control program stored in the program ROM of a ROM 13 or a control program which is stored in an external memory 14 and loaded to a RAM 19. The program ROM of the ROM 13 stores the control program for the CPU 12. The font ROM of the ROM 13 stores font data or the like used to generate the output information. The data ROM of the ROM 13 stores information used by the host computer 100 for a printer which does not comprise the external memory 14 such as a hard disk.

The CPU 12 can communicate with the host computer 100 via an input unit 18, and notify the host computer 100 of information of the printer 107 or the like. The RAM 19 functions as the main memory or work area of the CPU 12. The memory capacity of the RAM 19 can be expanded by an optional RAM connected to an expansion port (not shown). The RAM 19 is used as an output information mapping area, environment data storage area, NVRAM, or the like. The access of the external memory 14 such as a hard disk (HD) or IC card is controlled by a memory controller (MC) 20. The external memory 14 is connected as an option, and stores font data, emulation programs, form data, and the like. An operation panel 21 comprises operation switches, LED display, and the like.

The number of external memories 14 is not limited to one. A plurality of external memories including an optional card which store programs for interpreting the printer control languages of different language systems in addition to internal fonts may be connected. An NVRAM (not shown) may be arranged to store printer mode setting information from the operation panel 21.

The host computer 100 comprises the files, application, despooler, driver, and the like described above with reference to FIG. 1. The electronic original file 103 is generated via the electronic original writer 102 from a document file (application data) generated by the application 101. As described above, the electronic original file 103 can be opened by the bookbinding application 104. The bookbinding application 104 displays an operation window as shown in FIG. 10 on the display 210. The main difference between the bookbinding application 104 and the general-purpose application 101 is that the bookbinding application 104 has a print setting function which is generally provided by the printer driver 106. With this print setting function, unlike the general-purpose application 101, the bookbinding application 104 can achieve function settings of the printer 107 such as staple and punch for the electronic original file, in addition to editing functions such as replacement of document pages, copy, and delete. The electronic original file can be printed using a designated printer. The bookbinding application 104 described in the first embodiment is also called a print setting application.

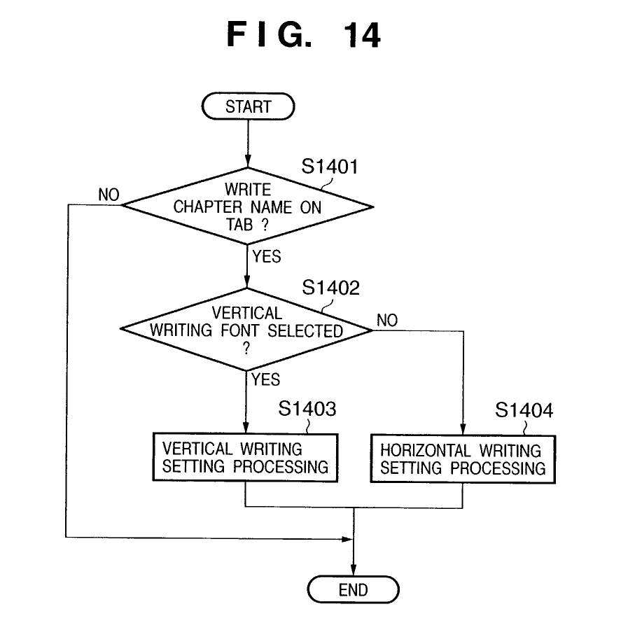

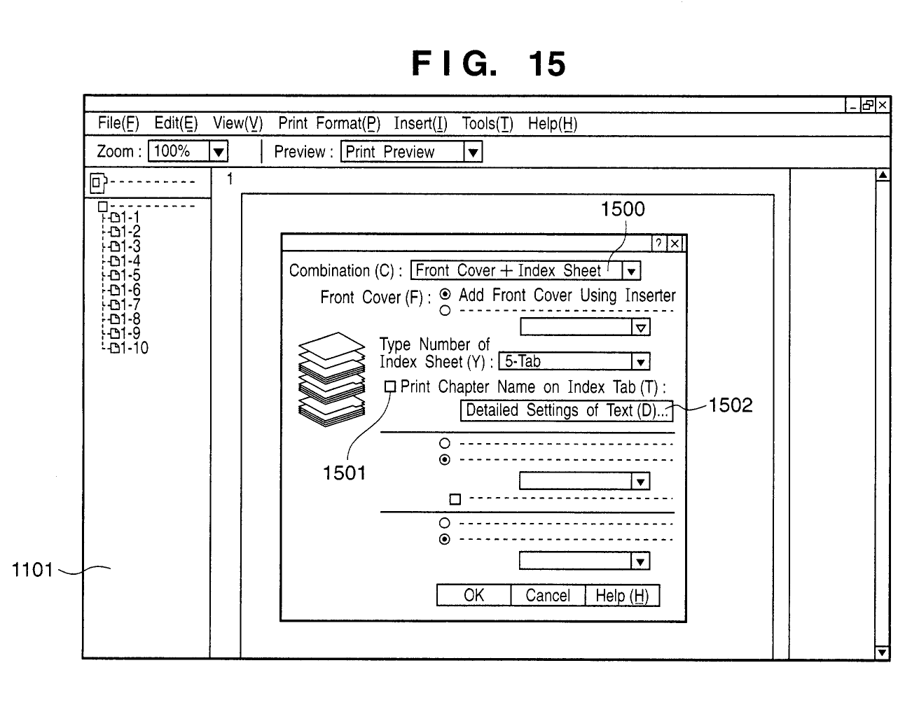

FIG. 14 is a flow chart showing processing when insertion of a front cover or index sheet to the document of an electronic original file is designated using a “paper insertion setting” function (one of unique print setting functions that the general application 101 does not have) of the bookbinding application 104 in the document processing system according to the first embodiment, and the name of a chapter is printed on the tab of the index sheet. In the first embodiment, the index sheet is inserted at a chapter break.

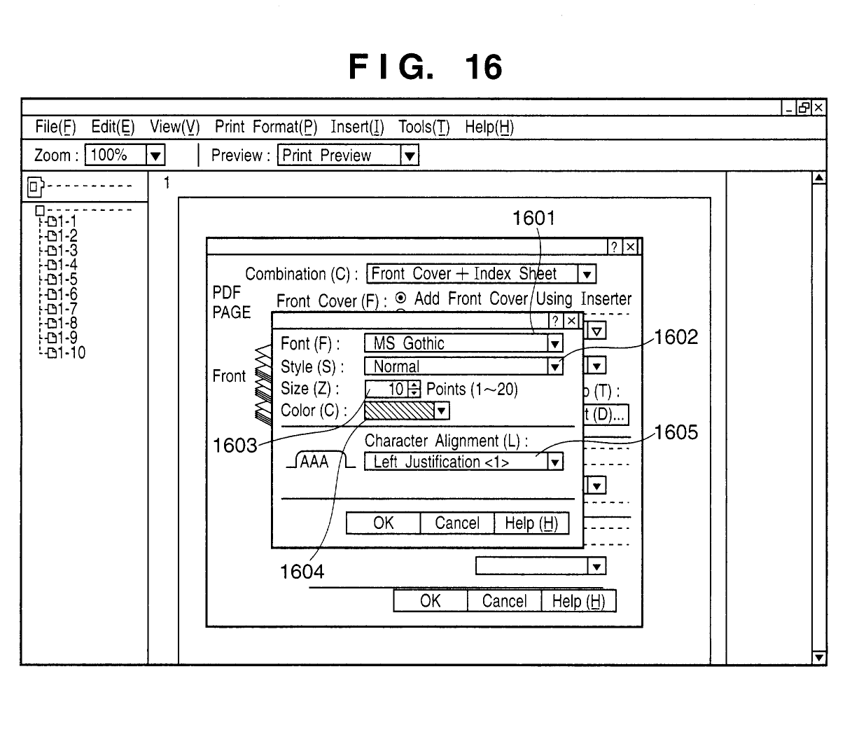

Before a description of the flow chart of FIG. 14, an example of “paper insertion setting” will be explained with reference to FIGS. 15 and 16.

FIG. 15 shows a display example of a “paper insertion setting” window by the bookbinding application 104 according to the first embodiment.

In FIG. 15, reference numeral 1500 denotes an area for designating a combination of paper sheets to be inserted. In FIG. 15, insertion of a front cover and index sheet is designated, and “front cover+index sheet” is displayed. In addition, all of “front cover, index sheet, slip sheet, and back cover”, a combination of any of them, or only one of them can be set. “Front cover”, “index sheet”, “slip sheet”, and “back cover” designated in the dialog box do not exist as actual document data in an electronic original file, but are managed as print setting information in the electronic original file. Thus, an index sheet can be inserted or deleted by only changing print settings in the dialog box (unchecking the check box or changing the tag), greatly improving the user operability.

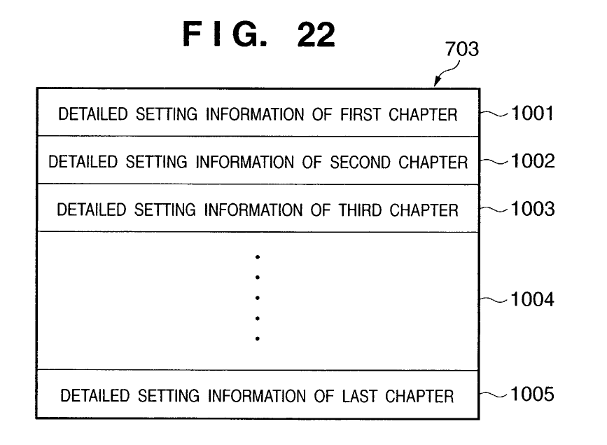

The “print name of chapter on tab of index sheet” is checked in a check box 1501. This setting allows designating to print the name of each chapter (stored in advance as setting information of each chapter (FIG. 22)) displayed at the tree portion 1101 on the tab of an index sheet inserted every chapter.

FIG. 16 is a view showing a display example of a window which is opened by designating a “detailed settings of text” 1502 in FIG. 15 provided by the bookbinding application 104 and is used to set details of a character string (chapter name) to be written on the tab of an index sheet.

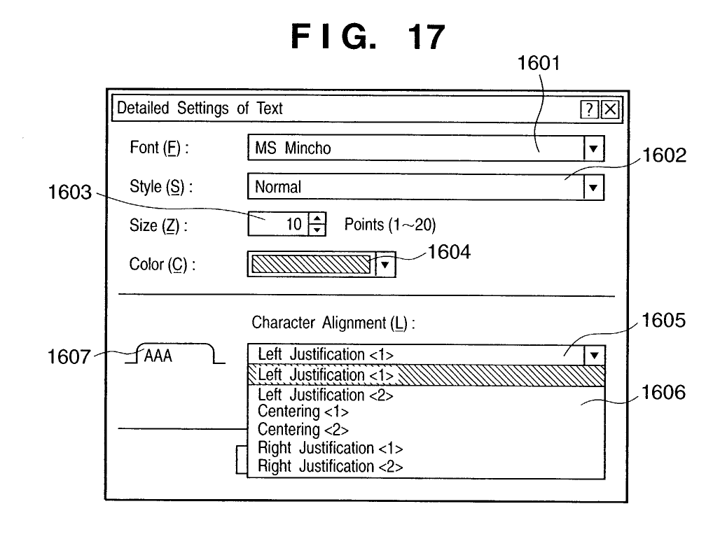

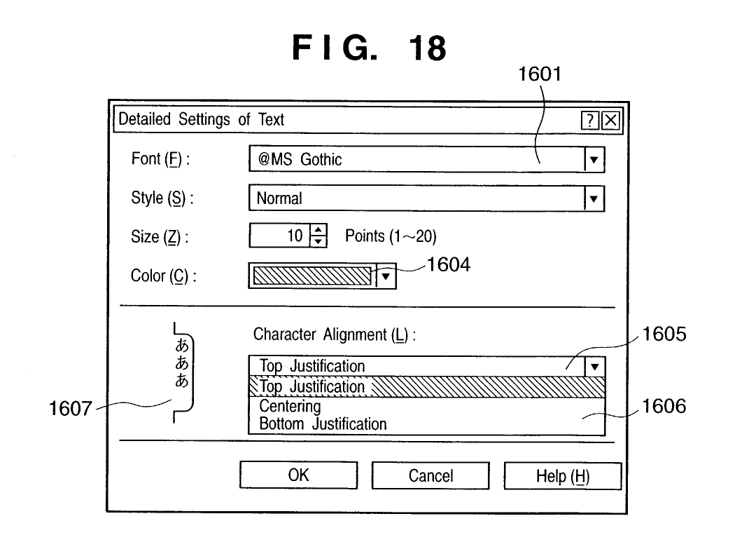

The character font and size of a text used to print a chapter name on a tab can be selected in the window of FIG. 16. Candidates in the layout designation column are automatically changed by selecting whether to select a horizontal writing font or vertical writing font in the font designation column of the window in FIG. 16. When the horizontal writing font is selected, the window is changed as shown in FIG. 17. When the vertical writing font is selected, the window is changed as shown in FIG. 18. FIGS. 17 and 18 are enlarged views showing these windows.

The bookbinding application 104 as a print control program according to the first embodiment provides a tab setting window as shown in FIG. 16. The user can easily set a character to be printed on a tab sheet (index sheet) added to a document. Unlike the prior art, index sheet data need not be generated as a document page. To change the insertion position of an index sheet in a document, the page position of the index sheet is only changed in the preview window of the bookbinding application 104 with a simple operation. To add an index sheet, addition of the index sheet is only designated, thus improving the operability.

In this case, a horizontal writing font “MS Mincho (for KANJI and KANA characters)” is selected, and the user can select a desired layout from options in a column 1606 as shown in FIG. 17. Since a “left justification <1>” 1605 is selected in FIG. 17, a chapter name is printed in a layout (1607) in which a character string is left-justified on a tab, with the tab of the index sheet being located on the top. If “left justification <2>” is selected, a chapter name is printed in a layout in which a character is left-justified on a tab, with the tab of the index sheet being located at the bottom. In this fashion, when the horizontal writing font is selected, the bookbinding application 104 can cope with printing with the tab of an index sheet being located on the top and printing with the tab of an index sheet being located at the bottom.

Reference numeral 1602 denotes an area for designating a style (normal in FIG. 17); numeral 1603 denotes an area for setting a character size (10 points in FIG. 17); and numeral 1604 denotes an area for setting a character color. The area 1605 displays a layout selected from the column 1606. The area 1607 represents the format of a character (left justification in FIG. 17) to be actually printed on a tab.

FIG. 18 depicts a view showing a display example of a window when a vertical writing font is selected in the window for setting details of a character string to be printed on the tab of an index sheet.

In FIG. 18, a vertical writing font “@MS Gothic” is selected in a font designation area 1601. In this case, the column 1606 displays “top justification”, “centering”, and “bottom justification”, and the user can select a desired layout from them. In FIG. 18, “top justification” is selected in the column 1606. The area 1605 displays “top justification”, and the area 1607 represents a setting of printing a chapter name on a tab in the “top justification” layout with the tab of the index sheet being located on the right. In FIG. 18, any one of “top justification”, “centering”, and “bottom justification” is selected as a layout on the tab of an index sheet. Alternatively, a designation column for “left opening” and “right opening” as the opening direction of a print material may be set in print settings by the bookbinding printing application 104. When “left opening” is selected by designation of the opening direction, the layout may be selected as shown in FIG. 18. When “right opening” is selected, “top justification <2>”, “centering <2>”, and “bottom justification <2>” (not shown) may be selected. The layout <2>means a layout in which a chapter name is printed with the tab of an index sheet being located on the left.

The flow chart of FIG. 14 will be described based on the above premise.

In step S1401, the bookbinding application 104 checks whether the check box 1501 has been checked, and determines whether to write a chapter name on a tab. If YES in step S1401, the flow advances to step S1402 and proceeds to processing of selecting a font to be used to print the chapter name, number, or the like on the tab. The bookbinding application 104 checks whether the selected font is a vertical writing font. This is determined in accordance with the type of selected font. For a vertical writing font, the flow advances to step S1403, and the bookbinding application 104 performs vertical writing tab setting processing. In vertical writing tab setting processing, the bookbinding application 104 provides a display window in which the character style, character size, character color, character alignment, and the like are set, as shown in the display window example of FIG. 18. The bookbinding application 104 controls the display 210 via the OS to display this window. As described above, the bookbinding application 104 may check whether the opening direction is “right opening” or “left opening”, and change layout candidates for the tab of an index sheet in accordance with the opening direction. If a horizontal writing font is selected, the flow advances to step S1404, and the bookbinding application 104 performs horizontal writing tab setting processing. In horizontal writing tab setting processing, the bookbinding application 104 provides a display window in which the character style, character size, character color, character alignment, and the like are set, as shown in the display window example of FIG. 17. The bookbinding application 104 controls the display 210 via the OS to display this window.

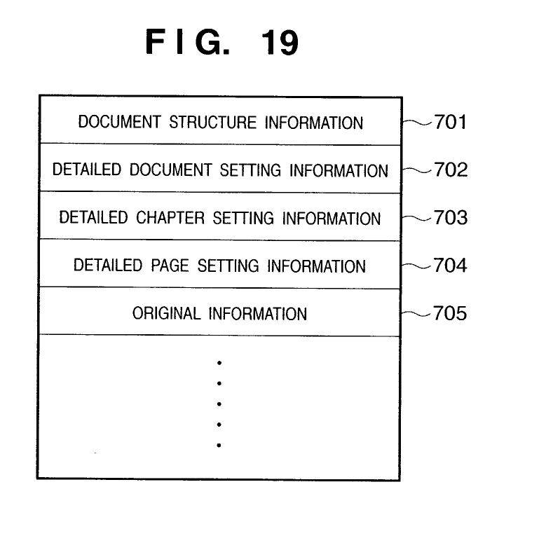

FIG. 19 is a view for explaining the data structure of a document file processed by the application 101 according to the first embodiment. The document file corresponds to the electronic original file 103 in FIG. 1. The document file is stored in the external memory 211 in FIG. 13, but may be stored in the database 1211 of the document management server 1201 in FIG. 12.

In FIG. 19, document structure information 701 stores information about a document structure displayed at the tree portion 1101 of the application operation window shown in FIG. 10. Detailed document setting information 702 is an area for storing information settable for the entire document. Detailed chapter setting information 703 is an area for storing information settable for each chapter. Detailed page setting information 704 is an area for storing information settable for each page. Original information 705 stores drawing information of each original page, and holds information of each page used for display at the preview portion 1102 on the right side of FIG. 10. Note that the document file includes another information necessary for each document, but a description thereof will be omitted.

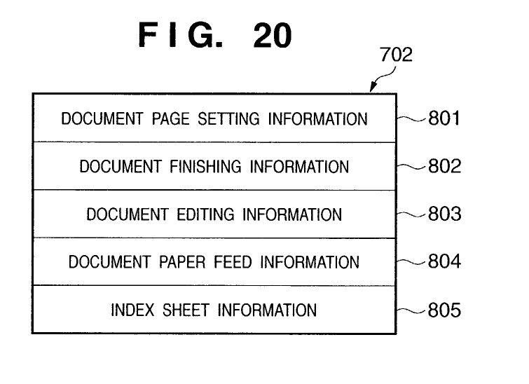

FIG. 20 is a view for explaining in more detail the data structure of the detailed document setting information 702 in FIG. 19.

Reference numeral 801 denotes document page setting information; numeral 802 denotes document finishing information; numeral 803 denotes document editing information; numeral 804 denotes document paper feed information; and numeral 805 denotes index sheet information. These pieces of information are stored as the detailed document setting information 702. If index sheet setting is done using the operation window shown in FIG. 15, the pieces of setting information are added to the index sheet information 805.

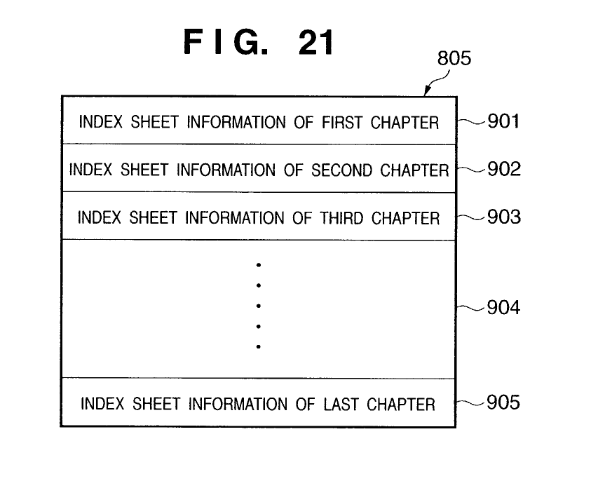

FIG. 21 is a view for explaining information stored in the index sheet information 805 of FIG. 20 in more detail.

In FIG. 21, reference numeral 901 denotes index sheet information of the first chapter; and numeral 902 denotes index sheet information of the second chapter. Pieces of index sheet information (903 to 905) are stored in successive areas sequentially up to the last chapter. For example, when the use of an index sheet as shown in FIG. 15 is set, an index sheet is inserted at the beginning of each chapter. For this purpose, index sheet information columns are ensured by the number of chapters.

FIG. 22 is a view showing in more detail the data structure of the detailed chapter setting information 703 shown in FIG. 19.

Pieces of detailed setting information (1001 to 1005) of the first chapter to the last chapter are stored. Detailed setting information of each chapter also stores the above-mentioned chapter name to be printed on the tab of an index sheet.

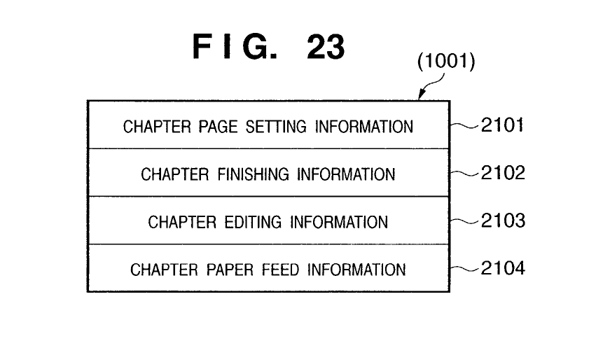

FIG. 23 is a view for explaining the data structure of each of the pieces of detailed setting information (1001 to 1005) of chapters shown in FIG. 22.

In FIG. 23, reference numeral 2101 denotes chapter page setting information which stores the name of a chapter; numeral 2102 denotes chapter finishing information; numeral 2103 denotes chapter editing information; and numeral 2104 denotes chapter paper feed information. These pieces of information are stored as detailed setting information of each chapter.

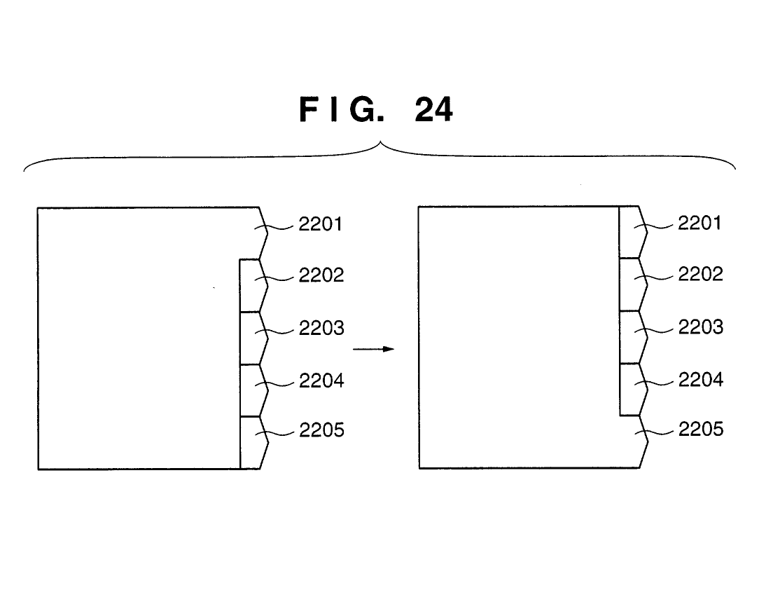

FIG. 24 is a view for explaining editing of details of an index sheet after “index sheet insertion setting” in FIG. 15.

In FIG. 24, all index sheets (five sheets in FIG. 24) which overlap each other are displayed in an editing window. The tab of an index sheet to be edited is designated with a mouse cursor pointed by a mouse serving as a pointing device. The mouse is clicked to display the designated index sheet on the top page so as to be edited. For example, the index sheet of the first chapter is editable in an initial window shown on the left side of FIG. 24. An index sheet with a tab 2201 is active and can be edited. In this state, for example, a tab 2205 is clicked. Then, the index sheet (fifth sheet) with the tab 2205 is displayed on the top, and editing of this index sheet becomes active. The tab of the active index sheet and the contents of the index sheet can be edited.

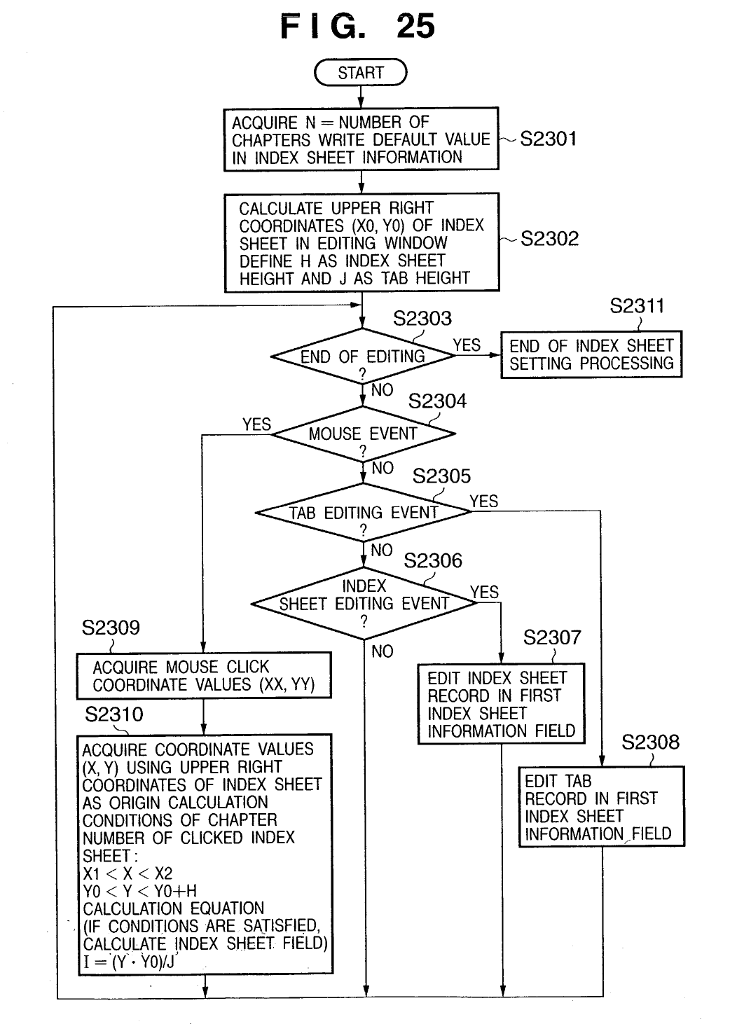

FIG. 25 is a flow chart showing details of index sheet setting and preview display processing by the application 101 in the document processing system according to the first embodiment.

The application 101 ensures areas for recording index information by the number of chapters included in a document, as shown in FIG. 21, while index sheet setting is performed on the index sheet insertion setting dialog (FIG. 15).

If an index sheet is set for the first time, the index sheet information areas of respective chapters are ensured by the number (N) of chapters in the index sheet information 805, and the default values of pieces of index sheet information are written in the areas in step S2301, as shown in FIG. 21. Information for obtaining the effective coordinates of the tab region of the index sheet is calculated in step 2302 by editing operation of the index sheet. For example, the X-coordinate range (X1 and X2) of a tab position for upper right coordinates (X0, Y0) on the index sheet as an origin, an index sheet height H, and a tab height J are obtained in advance.

If any event occurs by user editing operation in step S2303 and subsequent steps, processing corresponding to the event is executed. For example, if the mouse serving as a pointing device is clicked on the index sheet as an event of selecting an index sheet to be edited, the flow proceeds from step S2304 to step S2309 to read coordinate values (XX, YY) where the mouse is clicked. The flow proceeds to step S2310 to convert the coordinate values (XX, YY) in the mouse-clicked window into coordinate values (X, Y) using the upper right coordinate values (X0, Y0) on the index sheet as an origin. Whether the mouse has been clicked within the effective coordinate range of the tab region is checked based on the converted coordinate values (X, Y). If the X and Y values of the converted coordinate values (X, Y) satisfy conditions: X1<X<X2 and Y0<Y<(Y0+H), this means that the tab of any index sheet has been designated with the mouse cursor. Then, the index sheet corresponding to the designated tab is obtained. In this case, the integer part of {(Y−Y0)/J} is calculated to obtain the number of the designated index sheet with respect to the number “0” of the first index sheet. This number represents an area where editing information is to be stored, i.e., a chapter number in the index sheet information storage area shown in FIG. 21.

If the event is not a mouse event in step S2304, the flow advances to step S2305 to check whether a tab editing event has occurred. If YES in step S2305, the flow advances to step S2308 to switch the current window into an editing window for printing a chapter name to be written on the tab of the index sheet. A character style set using this window is stored in index sheet information (FIG. 21) of the chapter designated by the chapter number obtained in step S2310. Details of processing in step S2308 are shown in the flow chart of FIG. 14.

If NO in step S2305, the flow proceeds to step S2306 to check whether an index sheet editing event has occurred. If YES in step S2306, the flow shifts to step S2307 to switch the current window to an index sheet editing window. Information edited in step S2307 is stored in index sheet information (FIG. 21) designated by the chapter number obtained in step S2310.

If an editing end event occurs in step S2303, the flow proceeds to step S2311, and index sheet setting processing ends on the basis of the information edited by the previous operation.

In this manner, the user can set the layout of a character string on the tab of an index sheet in an arbitrary direction in accordance with the orientation of the index sheet.

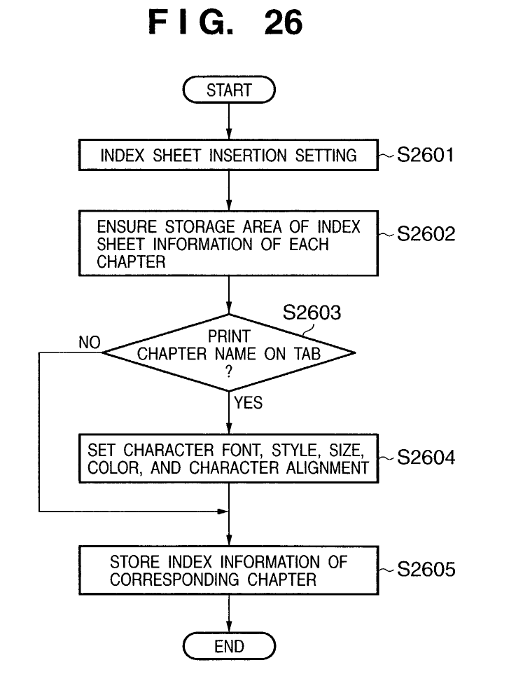

FIG. 26 is a flow chart showing the whole index sheet information input processing.

If index sheet setting processing is activated using the window of FIG. 15 in step S2601, the flow advances to step S2602, and the bookbinding application 104 ensures index sheet information storage areas by the number of necessary chapters on the basis of the number of set index sheets, as shown in FIG. 21. In step S2603, the bookbinding application 104 checks whether it is designated in the check box 1501 to print a chapter name on the tab of an index sheet. If YES in step S2603, the flow proceeds to step S2604 to designate the font, style, size, color, and character alignment of characters to be printed on the tab (FIGS. 16 to 18). The flow proceeds to step S2605 to store index sheet information together with the set tab information as index sheet information of the chapter. If NO in step S2603, the flow proceeds to step S2605 to store the index sheet information.

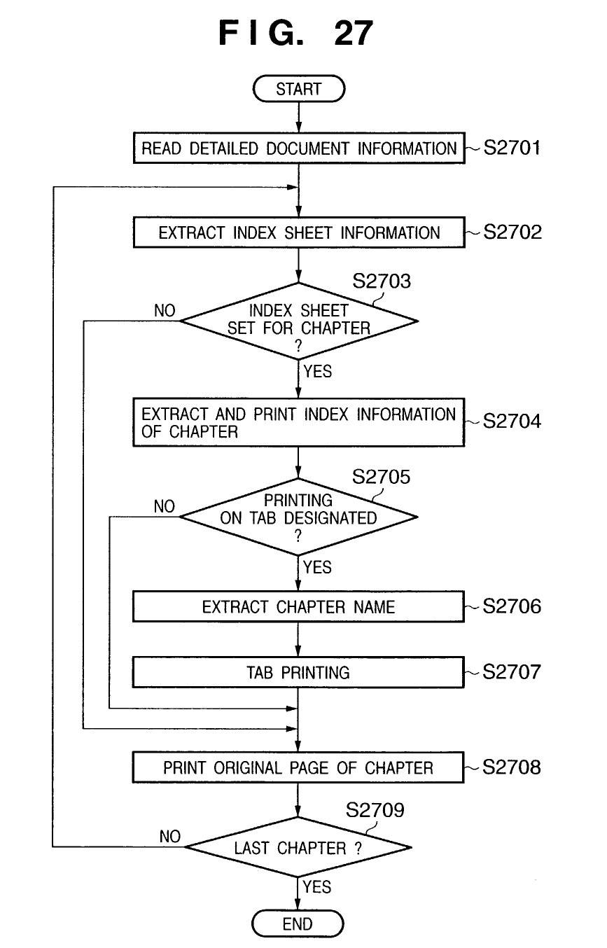

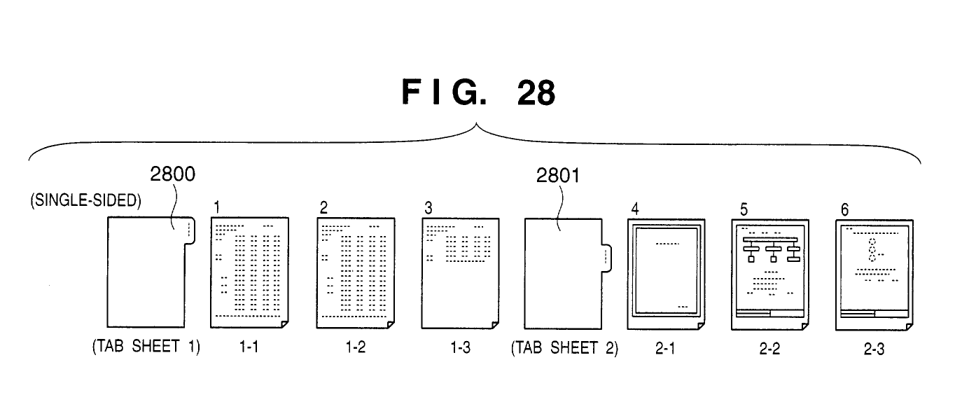

FIG. 27 is a flow chart showing document information print processing according to the first embodiment.

The electronic original despooler 105 reads the detailed document setting information 702 among document information shown in FIG. 19 in step S2701, and extracts the index sheet information 805 (FIG. 20) contained in the information 702 in step S2702. Whether index sheet information is set for the current chapter is checked based on the information 805 (FIG. 21). If index sheet information is set, the flow advances to step S2704, and the electronic original despooler 105 extracts index sheet information of the chapter and performs printing on an index sheet. Then, the flow advances to step S2705 to check whether to print a chapter name on the tab of the index sheet. If YES in step S2705, the flow proceeds to step S2706 to read out the chapter name corresponding to the chapter from corresponding detailed chapter setting information. In step S2707, the electronic original despooler outputs a GDI function to a graphic engine (GDI) serving as the drawing means of the OS so as to print the chapter name on the tab of the index sheet in accordance with the designated font, character size, character alignment, and the like which are stored as corresponding index sheet information. The graphic engine converts the GDI function into a drawing function (DDI function) interpretable by the printer driver 106. As described above, the printer driver 106 generates print data in a printer control language interpretable by the printer 107 in accordance with the drawing function transferred from the graphic engine. As a result, tab sheet print processing is executed.

If no index sheet information is set for the chapter in step S2703 or no tab printing is designated in step S2705, the flow advances to step S2708. The electronic original despooler 105 executes print processing by outputting the GDI function to the graphic engine so as to print each original page on the basis of original page information contained in the chapter. After all the original pages of the chapter are printed, the flow proceeds to step S2709 to check whether the chapter is the last one. If NO in step S2709, the flow returns to step S2702 again. The electronic original despooler 105 extracts the index sheet information 805 of the next chapter (FIG. 20), and executes the same processing as described above. If print processing ends for all the original pages of all the chapters of the document and added index sheets, the print processing ends.

To display the print preview of document information, “to print” is changed to “to rasterize to a print preview and display it” in the flow chart of FIG. 27. The print preview of set index sheets and original pages can be displayed.

FIG. 28 depicts a view showing an example of the print preview displayed in this way.

In FIG. 28, each of index sheets 2800 and 2801 is inserted at the beginning of a corresponding one of chapters, and the print preview 1102 is displayed. The index sheets 2800 and 2801 are displayed with tabs attached to them. Character strings on the tabs are also displayed in accordance with the set character size, character font, character alignment, and the like. This preview enables confirming at a glance page positions where the index sheets are inserted. The tab positions of the index sheets are displayed in a layout with downward shifts sequentially from the first index sheet 2800, and the paper shapes of the index sheets can also be grasped at a glance.

By this processing, a character string complying with index sheet information designated in the window shown in FIG. 16 can be printed on the tab of an index sheet.

Index sheet information can designate a character size. However, a long character string to be printed on a tab may not be completely printed within the tab in the designated character size. In this case, character size adjustment processing and line feed processing can be executed to extend index sheet information so as to achieve processing of making the character string fall within the tab.

Extended processing of making a character string fall within a tab will be explained.

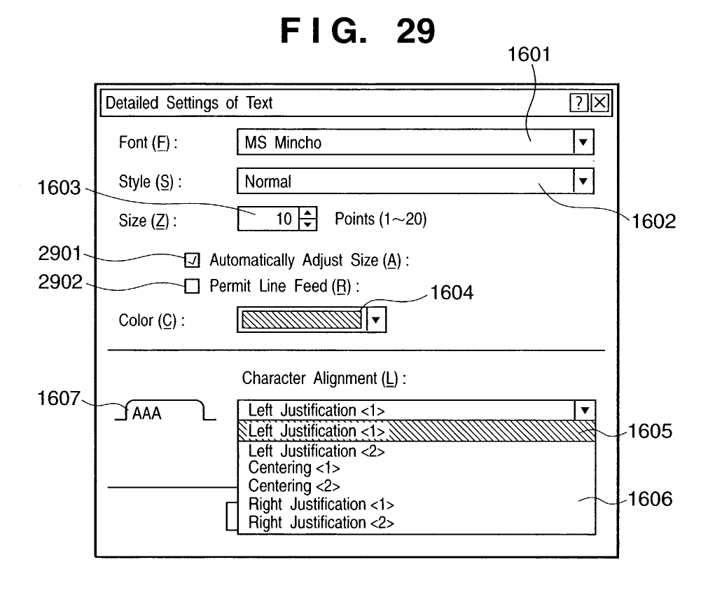

FIG. 29 is a view showing an extended example of the window (FIGS. 16 and 17) for setting details of a character string (chapter name) to be written on the tab of an index sheet. The same reference numerals as in FIGS. 16 and 17 denote the same parts.

In FIG. 29, an “automatically adjust size” check box 2901 is checked (ON). If a designated character string does not fall within the tab in a character size designated by the “size” 1603, processing of automatically adjusting the size of the character string to a character size which allows the character string to fall within the tab becomes effective. More specifically, the size designated by the “size” 1603 is automatically changed when the character string does not fall within the tab in the designated size, unlike the above-described embodiment in which the character string is always printed in the designated size.

When the “automatically adjust size” check box 2901 is ON, a “permit line feed” check box 2902 can be designated. This check box 2902 is checked, and then processing of printing a character string in two lines by line feed becomes effective when the automatically adjusted character size is smaller than a predetermined character size. The predetermined character size is held in a program, and serves as a threshold value for determining that a character string should be printed in two lines instead of printing it in one line with a smaller character size. This size is not too small to identify a character by the user. The predetermined character size is held by a fixed value in the program. However, the present invention is not limited to this, and a UI (User Interface) for designating a character size can be added to the window shown in FIG. 29 to control the character size as a variable.

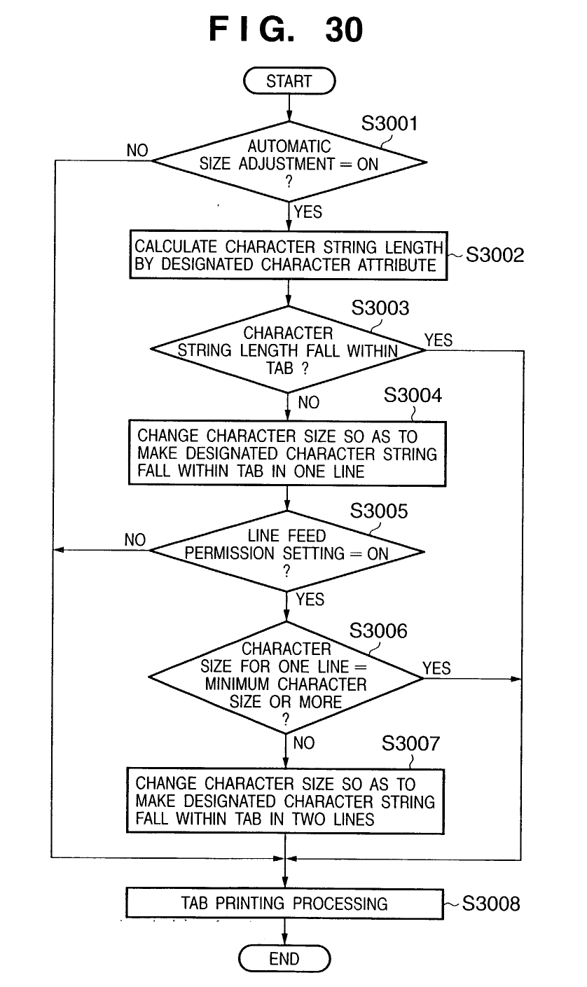

FIG. 30 is a flow chart showing adjustment processing of a character size to be printed within a tab, and line feed processing according to the embodiment. This processing will be described with reference to FIG. 29.

In step S3001, the electronic original despooler 105 checks whether the “automatically adjust size” check box 2901 is ON. If NO in step S3001, the flow advances to step S3008 to output the GDI function of drawing information to be printed on a tab sheet so as to print designated characters on the tab in a character size designated by the “size” 1603.

If YES in step S3001, the flow advances to step S3002. The electronic original despooler 105 checks the length of the designated character string (chapter name) on the basis of the font, character size, and another attribute designated by the pieces of information 1601, 1602, and 1603 in FIG. 29. The flow advances to step S3003 to check whether the length of the character string obtained in step S3002 falls within the tab.

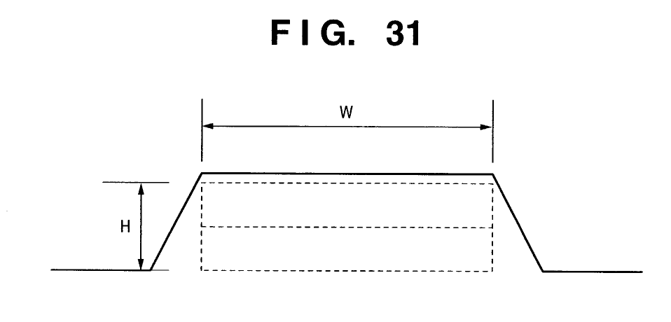

FIG. 31 is a view for explaining the printable region of the tab.

The printable region is defined by a width W and height H. If the calculated length of the character string is W or less, the character string is determined to fall within the printable region of the tab; otherwise, determined not to fall within the printable region.

If the character string is determined to fall within the printable region of the tab, the flow proceeds to step S3008. The electronic original despooler 105 outputs a drawing function so as to print the set character string on the tab in the character size designated by the “size” 1603. The printer driver 106 operates to generate print data.

If NO in step S3003, the flow shifts to step S3004, and the electronic original despooler 105 obtains a character size which allows the character string to fall within one line on the tab. In other words, the electronic original despooler 105 obtains a character size with which the character string length becomes W or less. After that, the flow advances to step S3005 to check whether the “permit line feed” check box 2902 in FIG. 29 is ON. If NO in step S3005, the flow proceeds to step S3008 to output a drawing function so as to print the character string on the tab in the character size obtained in step S3004. The printer driver 106 shifts to print data generation processing. In this case, the designated character string is printed in one line on the tab, and the character size may become very small in accordance with the character string length.

If YES “permit line feed” in step S3005, the flow advances to step S3006, and the electronic original despooler 105 checks whether the character size obtained in step S3004 is equal to or smaller than the predetermined character size described above, i.e., the maximum character size printable in two lines, and is not too small to identify characters by the user. If YES in step S3006, the flow proceeds to step S3008, and the electronic original despooler 105 outputs a drawing function so as to print the character string on the tab in the character size obtained in step S3004. Also in this case, the designated character string is printed in one line on the tab with an appropriate character size of the character string.

If NO in step S3006, the flow advances to step S3007. The electronic original despooler 105 obtains a character size which allows the character string to fall within two lines, and outputs the drawing function of the character string so as to print the character string in two lines on the tab in step S3008. The character size for two lines obtained in step S3007 is a smaller one of a character size with which the character string length coincides with a total length of two lines, i.e., attains a value expressed by (W×2) in FIG. 31, and a character size with which the line height falls within two lines on the tab, i.e., attains a value (H/2) in FIG. 31.

In general, a character string is divided into two lines in consideration of line boundary character check processing corresponding to a language to be used. The first embodiment can also execute this processing. To print a character string in two lines in step S3008, divided character strings are printed in two divided print regions shown in FIG. 31 on the basis of the designated character alignment. Processing of printing a character string in two lines is well known, and a detailed description thereof will be omitted.

[Second Embodiment]

In the first embodiment, character alignment in the character format printed on the tab of an index sheet is changed depending on whether the font designated in the font designation column of the window in FIG. 16 is a horizontal or vertical writing font. In the second embodiment, a character string can be printed by vertical writing using, e.g., a European font which is originally a horizontal writing font. A document processing system according to the second embodiment has basically the same hardware arrangement as that according to the first embodiment, and a description thereof will be omitted.

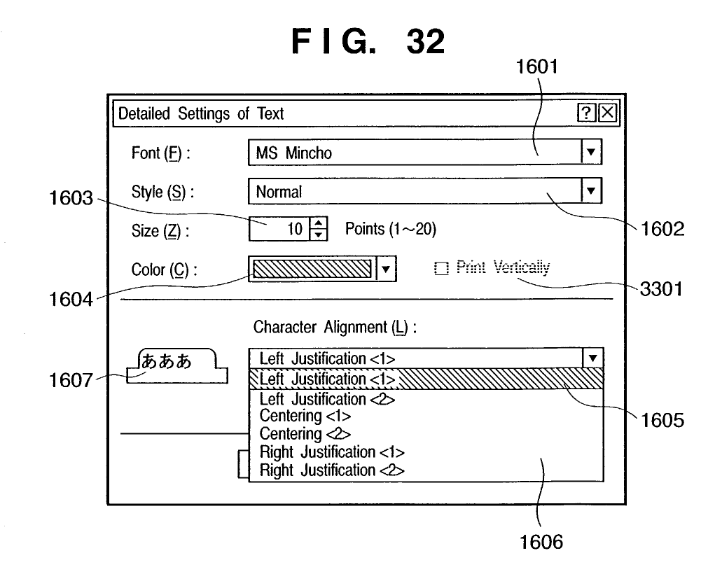

FIGS. 32 to 35 are views showing window examples for designating a character to be printed on a tab according to the second embodiment of the present invention. The same reference numerals as in FIGS. 16 to 18 denote the same parts.

In FIG. 32, a Japanese horizontal writing font “MS Mincho (for KANJI and KANA characters)” is selected in a font designation area 1601. In this case, a column 1606 displays “left justification”, “centering”, and “right justification”, and the user can select a desired layout from them. Since “left justification <1>” is selected in the column 1606 in FIG. 32, an area 1605 displays “left justification <1>”, and an area 1607 represents a setting of horizontally printing a chapter name “ [symbol] [symbol] [symbol] ” on a tab in the “left justification” layout. The second embodiment adopts a “print vertically” column 3301 which designates to forcibly print vertically. In the example of FIG. 32, the Japanese horizontal writing font is selected, and the column 3301 is grayed out so as not to select “print vertically”.

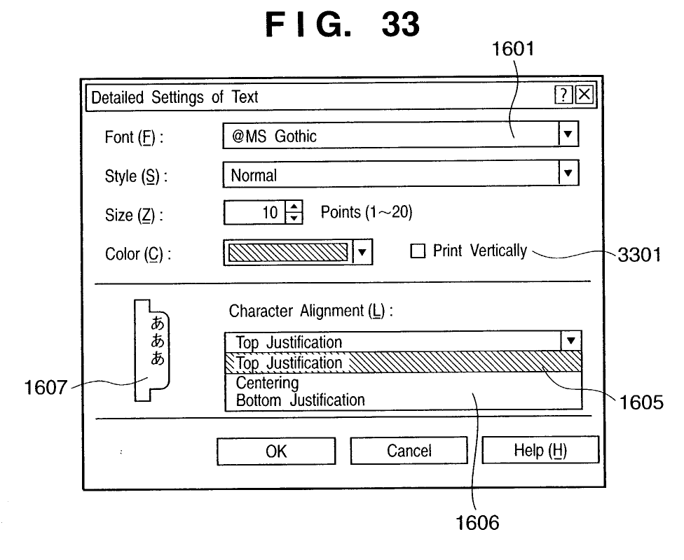

In FIG. 33, a Japanese vertical writing font “@ MS Gothic (for KANJI and KANA characters)” is selected in the font designation area 1601. In this case, the column 1606 displays “top justification”, “centering”, and “bottom justification”, and the user can select a desired layout from them. In FIG. 33, “top justification” is selected in the column 1606. The area 1605 displays “top justification”, and the area 1607 represents a setting of vertically printing a chapter name “ [symbol] [symbol] [symbol] ” on the tab of an index sheet in the “top justification” layout, with the tab of the index sheet being located on the right. In FIG. 33, any one of “top justification”, “centering”, and “bottom justification” is selected as a layout on the tab of an index sheet. Alternatively, a designation column for “left opening” and “right opening” as the opening direction of a print material may be set in print settings by a bookbinding printing application 104. When “left opening” is selected by designation of the opening direction, the layout may be selected as shown in FIG. 18. When “right opening” is selected, “top justification <2>”, “centering <2>”, and “bottom justification <2>” (not shown) may be selected. The layout <2>means a layout in which a chapter name is printed with the tab of an index sheet being located on the left.

The check box of the column 3301 can be selected only when a European font is selected in the font designation area 1601. When a Japanese font is selected, this check box is grayed out so as not to select it, as shown in FIGS. 32 and 33.

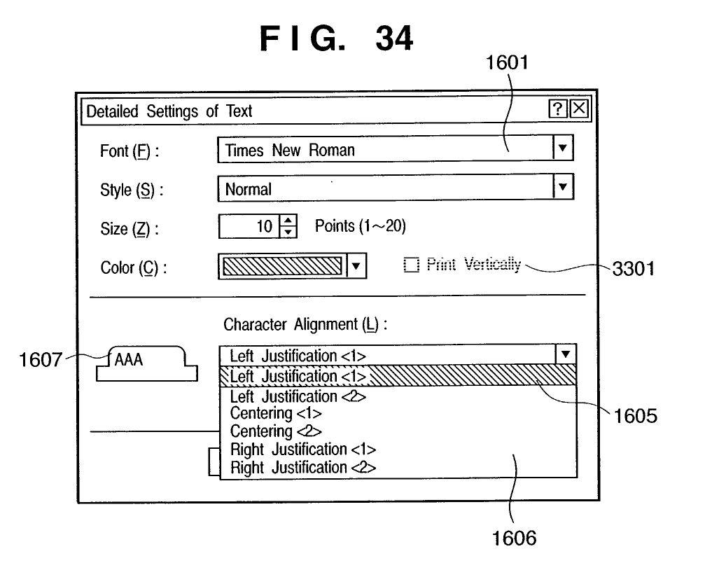

In FIG. 34, a European font “Times New Roman” which is not vertically printed in general is selected in the font designation area 1601. In this case, the column 1606 displays “left justification”, “centering”, and “right justification”, and the user can select a desired layout from them. Since “left justification <1>” is selected in the column 1606 in FIG. 34, the area 1605 displays “left justification <1>”, and the area 1607 represents a setting of horizontally printing a chapter name “AAA” on a tab in the “left justification” layout. In this case, the “print vertically” column 3301 can be designated, and the column 3301 and its check box are displayed to enable designating them.

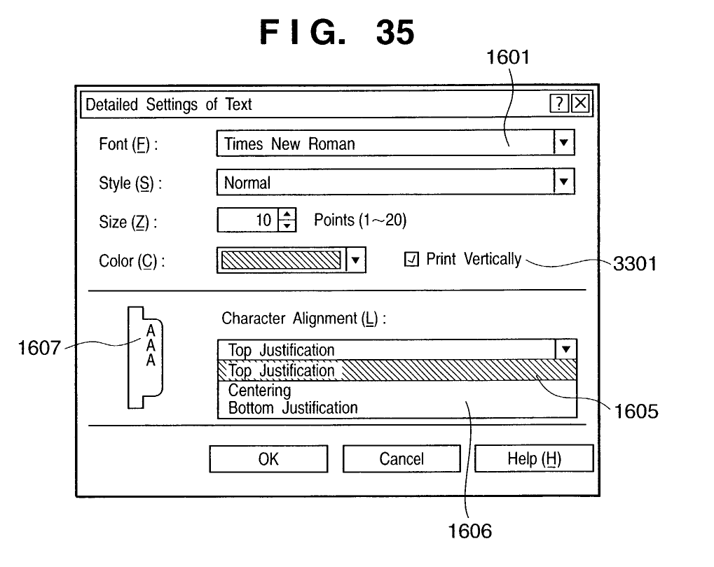

FIG. 35 is a view showing a state in which the check box of the column 3301 is checked in the state of FIG. 34.

More specifically, FIG. 35 shows a display example when a European font is selected in the column 1601 and the check box of the “print vertically” column 3301 is checked. In this case, the column 1606 displays “top justification”, “centering”, and “bottom justification”, and the user can select a desired layout from them. The area 1607 represents a setting of vertically printing a chapter name “AAA” on a tab in the “top justification” layout.

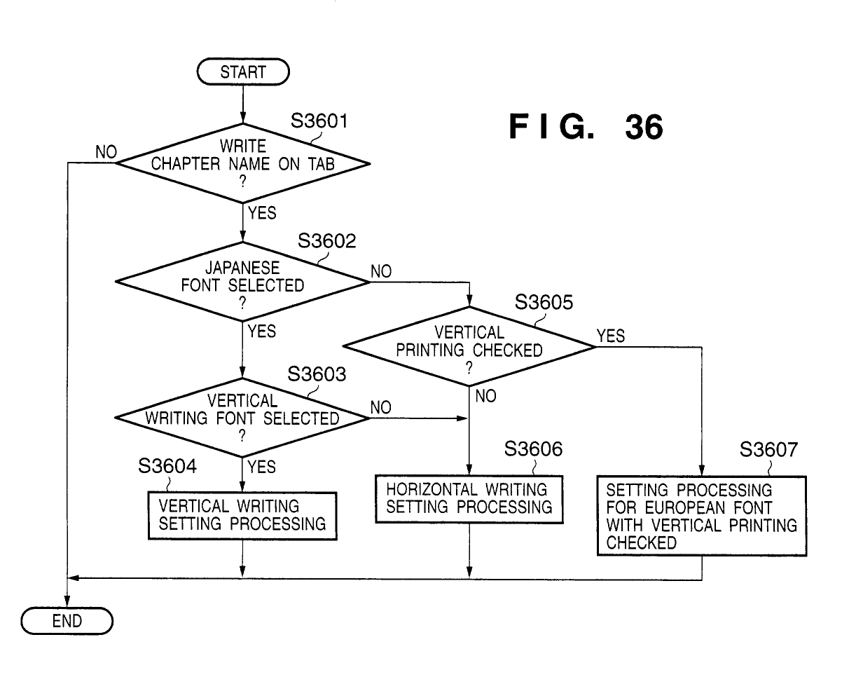

FIG. 36 is a flow chart for explaining write of a character string on a tab in the document processing system according to the second embodiment of the present invention. This processing flow chart is basically the same as the flow chart of FIG. 14 except that vertical printing can be performed using a European font.

In step S3601, the bookbinding application 104 checks whether a check box 1501 has been checked, and determines whether to write a chapter name on a tab. If YES in step S3601, the flow advances to step S3602 and proceeds to processing of selecting a font to be used to print the chapter name, number, or the like on the tab. The bookbinding application 104 checks whether the selected font is a Japanese font. If YES in step S3602, the flow advances to step S3603 to check whether a vertical writing font has been selected. If YES in step S3603, the flow advances to step S3604, and the bookbinding application 104 performs vertical writing tab setting processing. If NO in step S3603, the flow advances to step S3606, and the bookbinding application 104 performs horizontal writing tab setting processing. These processes are the same as steps S1401 to S1404 in FIG. 14.

If NO in step S3602, the flow advances to step S3605 to check whether the vertical printing check box 3301 has been checked. If YES in step S3605, the flow advances to step S3607 to perform setting processing of vertically printing a chapter name on a tab by the designated font. If NO in step S3605, the flow advances to step S3606 to perform general horizontal writing setting processing.

Vertical writing tab setting processing using a European font that is executed in step S3607 will be described in detail.

To vertically print a chapter name on a tab by a Japanese font, the user selects a Japanese vertical writing font, as shown in FIG. 33. Since the character string to be printed has the vertical writing font rotated through 90° to the left, the chapter name can be automatically vertically printed on the tab without any special processing.

To print on a tab by a European font, the check box of the “print vertically” 3301 is checked as shown in FIG. 35 to designate to execute vertical printing by the European font because the European font is not a vertical writing font.

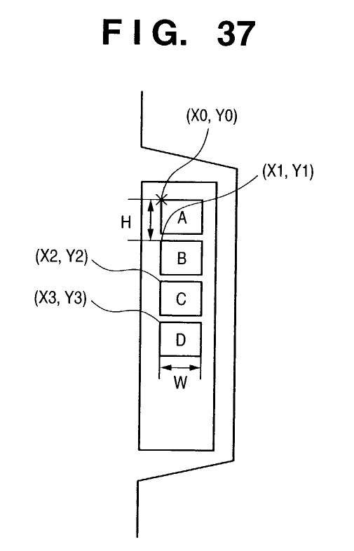

FIG. 37 is a view for explaining vertical printing by an European font.

This example exhibits a setting example of a tab by the bookbinding application 104 when a chapter name “ABCD” of the European font is vertically printed on the tab.

The bookbinding application 104 obtains the origin coordinates (X0, Y0) of the character region of the first character to be printed on the tab, a width W of the region of one character, and (height of one character+spacing between characters) H. By using the origin coordinates (X0, Y0) of the first character “A” as a reference, the bookbinding application 104 calculates the origin coordinates of the second and subsequent characters from (X1, Y1)=(X0, Y0+H), (X2, Y2)=(X0, Y0+2H), and (X3, Y3)=(X0, Y0+3H). The origin coordinates of characters are sequentially obtained as references for printing the characters. The obtained coordinate information of each character is stored in index sheet information 805 shown in FIG. 21.

In this way, even European fonts which are only horizontal writing fonts can be vertically printed.

The present invention may be applied to a system constituted by a plurality of devices (e.g., a host computer, interface device, reader, and printer) or an apparatus (e.g., a copying machine or facsimile apparatus) formed from a single device.

The object of the present invention is also achieved when a storage medium (or recording medium) which stores software program codes for realizing the functions of the above-described embodiments is supplied to a system or apparatus, and the computer (or the CPU or MPU) of the system or apparatus reads out and executes the program codes stored in the storage medium. In this case, the program codes read out from the storage medium realize the functions of the above-described embodiments, and the storage medium which stores the program codes constitutes the present invention. The functions of the above-described embodiments are realized when the computer executes the readout program codes. Also, the functions of the above-described embodiments are realized when an OS (Operating System) running on the computer performs part or all of actual processing on the basis of the instructions of the program codes.

The functions of the above-described embodiments are also realized when the program codes read out from the storage medium are written in the memory of a function expansion card inserted into the computer or the memory of a function expansion unit connected to the computer, and the CPU of the function expansion card or function expansion unit performs part or all of actual processing on the basis of the instructions of the program codes.

As has been described above, according to the above embodiments, the user can arbitrarily designate, e.g., a chapter name to be written on the tab of an index sheet. The user need not perform tab setting on one index sheet every chapter.

The user can select the layout of a character string to be written on a tab from options corresponding to a selected font, and write tab information. Index information can be set in consideration of the index sheet orientation and tab size.

The present invention is not limited to the above embodiments and various changes and modifications can be made within the spirit and scope of the present invention. Therefore, to apprise the public of the scope of the present invention, the following claims are made.

What is claimed is:

1. An information processing apparatus comprising:
tab setting means for setting information about a tab of an insertion paper sheet to be inserted between predetermined pages of document information; and
format setting/registering means for setting and registering a format of a character string to be printed on the tab of the insertion paper sheet set by said tab setting means,
wherein said tab setting means changes a setting candidate of a layout for printing on a tab of an index sheet in accordance with a font type of the character string to be printed on a selected tab.

2. The apparatus according to claim 1, further comprising:
document storage means for storing document information including at least pieces of information about a chapter and a page included in the chapter;
setting means for setting information about an insertion paper sheet to be inserted between predetermined pages of the document information stored in said document storage means;
paper information storage means for storing the information about the insertion sheet set by said setting means; and
print control means for controlling to perform printing on each page included in the document information and on the insertion paper sheet on the basis of the document information stored in said document storage means, the information about the insertion paper sheet stored in said paper information storage means, and the format registered by said format setting/registering means.

3. The apparatus according to claim 2, wherein said document storage means stores a name of each chapter included in the document information.

4. The apparatus according to claim 1, wherein the insertion paper sheet includes a tabbed index sheet.

5. The apparatus according to claim 1, wherein the insertion paper sheet is inserted every chapter of the document information, and a corresponding chapter name is printed on the tab.

6. The apparatus according to claim 1, wherein the format of the character string set and registered by said format setting/registering means includes at least a character font, character size, and character layout.

7. The apparatus according to claim 1, wherein the format of the character string set and registered by said format setting/registering means includes automatic character size adjustment setting.

8. The apparatus according to claim 2, wherein said print control means adjusts a character size so as to make the character string to be printed on the tab fall within a printable region of the tab.

9. The apparatus according to claim 1, wherein the format of the character string set and registered by said format setting/registering means includes setting which permits line feed.

10. The apparatus according to claim 8, wherein said print control means adjusts again the character size in two lines when the character size becomes not larger than a predetermined character size by making the character string to be printed on the tab fall within the printable region in one line.

11. The apparatus according to claim 2, wherein said print control means prints each page included in the document information and performs printing on the paper sheet in an order of pages in the document information and an order of inserting paper sheets.

12. The apparatus according to claim 1, further comprising character string direction designating means for designating a character string direction not set for the font type of the character string to be printed on the selected tab,
wherein said tab setting means sets the layout of the character string to be printed on the tab in the character string direction designated by said character string direction designating means.

13. An information processing method comprising:
a tab setting step of setting information about a tab of an insertion paper sheet to be inserted between predetermined pages of document information; and
a format setting/registering step of setting and registering a format of a character string to be printed on the tab of the insertion paper sheet set in said tab setting step,
wherein in said tab setting step, a setting candidate of a layout for printing on a tab of an index sheet is changed in accordance with a font type of the character string to be printed on a selected tab.

14. The method according to claim 13, further comprising:
a setting step of setting information about an insertion paper sheet to be inserted between predetermined pages of the document information stored in a document file which stores document information including at least pieces of information about a chapter and a page included in the chapter;
a paper information storage step of storing the information about the insertion sheet set in said setting step; and
a print control step of controlling to perform printing on each page included in the document information and on the insertion paper sheet on the basis of the document information, the information about the insertion paper sheet stored in said paper information storage step, and the format registered in said format setting/registering step.

15. The method according to claim 14, wherein the document file stores a name of each chapter in the document information.

16. The method according to claim 13, wherein the insertion paper sheet includes a tabbed index sheet.

17. The method according to claim 13, wherein the insertion paper sheet is inserted every chapter of the document information, and a corresponding chapter name is printed on the tab.

18. The method according to claim 14, wherein the format of the character string set and registered in said format setting/registering step includes at least a character font, character size, and character layout.

19. The method according to claim 13, wherein the format of the character string set and registered in said format setting/registering step includes automatic character size adjustment setting.

20. The method according to claim 14, wherein in said print control step, a character size is so adjusted as to make the character string to be printed on the tab fall within a printable region of the tab.

21. The method according to claim 13, wherein the format of the character string set and registered in said format setting/registering step includes setting which permits line feed.

22. The method according to claim 20, wherein in said print control step, the character size is adjusted again in two lines when the character size becomes not larger than a predetermined character size by making the character string to be printed on the tab fall within the printable region in one line.

23. The method according to claim 14, wherein in said print control step, each page included in the document information and the paper sheet are printed in an order of pages in the document information and an order of inserting paper sheets.

24. The method according to claim 13, further comprising a character string direction designating step of designating a character string direction not set for the font type of the character string to be printed on the selected tab,
wherein in said tab setting step, the layout of the character string to be printed on the tab is set in the character string direction designated in said character string direction designating step.

25. An information processing method comprising:
a setting step of setting information about an insertion paper sheet to be inserted between predetermined pages of document information;
a document management step of managing, in a document file of the document information, the information about the insertion paper sheet set in said setting step; and
an output step of reading out the information about the insertion paper sheet from the document file and outputting the information to a printer driver when the document information of the document file managed in said document management step is to be printed.

26. The method according to claim 25, wherein in said document management step, a plurality of pieces of input document information are managed as one document information in the document file.

27. The method according to claim 26, wherein in said document management step, the plurality of pieces of input document information are combined as different chapters into one document information, and
the insertion paper sheet includes a paper sheet inserted between chapters.

28. The method according to claim 25, further comprising a tab setting step of setting information about a tab of an insertion paper sheet to be inserted between predetermined pages of document information, and
a format setting/registering step of setting and registering a format of a character string to be printed on the tab of the insertion paper sheet set in said tab setting step,
wherein in said tab setting step, a setting candidate of a layout for printing on a tab of an index sheet is changed in accordance with a font type of the character string to be printed on a selected tab.

29. A program which executes the information processing method defined in claim 13.

30. A computer-readable storage medium which stores a program which executes the information processing method defined in claim 13.

31. An information processing apparatus comprising:
setting means for setting information about an insertion paper sheet to be inserted between predetermined pages of document information;
document management means for managing, in a document file of the document information, the information about the insertion paper sheet set by said setting means; and
output means for reading out the information about the insertion paper sheet from the document file and outputting the information to a printer driver when the document information of the document file managed by said document management means is to be printed.

32. The apparatus according to claim 31, wherein said document management means manages a plurality of pieces of input document information as one document information in the document file.

33. The apparatus according to claim 32, wherein
said document management means combines the plurality of pieces of input document information as different chapters into one document information, and
the insertion paper sheet includes a paper sheet inserted between chapters.

34. The apparatus according to claim 31, further comprising:
tab setting means for setting information about a tab of an insertion paper sheet to be inserted between predetermined pages of document information, and
format setting/registering means for setting and registering a format of a character string to be printed on the tab of the insertion paper sheet set by said tab setting means,
wherein said tab setting means changes a setting candidate of a layout for printing on a tab of an index sheet in accordance with a font type of the character string to be printed on a selected tab.

35. The apparatus according to claim 34, further comprising character string direction designating means for designating a character string direction not set for the font type of the character string to be printed on the selected tab, wherein said tab setting means sets the layout of the character string to be printed on the tab in the character string direction designated by said character string direction designating means.
